(19) United States
(12) Patent Application Publication
(10) Pub. No.: US 2024/0058992 A1
(43) Pub. Date: Feb. 22, 2024

(54) Modified Long Fiber Reinforced Polymeric Composite Flakes Having Progressive Ends, Methods of Providing the Same, and Articles Formed Therefrom Having Enhanced Strength and Impact Resistance

(71) Applicant: Greene, Tweed Technologies, Inc., Wilmington, DE (US)

(72) Inventors: Samuel Stutz, Champvent (CH); Nicolas Weibel, Echichens (CH); Frederic Perrottet, Monter/Glane (CH)

(73) Assignee: Greene, Tweed Technologies, Inc., Wilmington (DE)

(21) Appl. No.: 18/175,989

(22) Filed: Feb. 28, 2023

Related U.S. Application Data
(60) Provisional application No. 63/315,022, filed on Feb. 28, 2022.

(51) Int. Cl. B29B 9/14; B29B 9/04

(52) U.S. Cl. CPC B29B 9/14; B29B 9/04; B29K 2307/04

(57) ABSTRACT

Described are a method of providing a modified polymeric composite flake for use in forming articles, articles formed therefrom and modified polymeric composite flakes, wherein resulting articles formed from such modified polymeric composite flakes have enhanced tensile strength and impact resistance, particularly at high velocity, as well as a method for increasing the average tensile strength and/or the impact resistance of an article formed from polymeric composites by using the modified polymeric composite flakes herein. The method includes providing a composite having at least one polymeric matrix material and long reinforcing fibers of a first fiber material extending through the polymeric matrix material; and forming from the composite at least one flake, wherein the at least one flake comprises an exterior surface having an exterior edge, a portion of the exterior edge being configured to provide at least one exterior edge feature to the exterior edge of the at least one flake thereby providing a modified polymeric composite flake.

### CROSS-REFERENCE TO RELATED APPLICATIONS

This non-provisional patent application claims the benefit under 35 U.S.C. § 119(e) of U.S. Provisional Patent Application No. 63/315,022, filed Feb. 28, 2022, entitled, “Modified Long Fiber Reinforced Polymeric Composite Flakes Having Progressive Ends, Methods of Providing the Same, and Articles Formed Therefrom Having Enhanced Strength and Impact Resistance,” the entire disclosure of which is incorporated herein by reference.

### BACKGROUND OF THE INVENTION

### Field of the Invention

The invention relates to the field of formation of discontinuous long fiber polymeric composite articles from a discontinuous long reinforcing fiber feedstock in the form of flakes which may be formed from a continuous long fiber composite pre-preg such as tape, and more particularly to making such articles wherein the tensile strength, the impact resistance, particularly at high velocity, and fatigue limit of the resulting articles are increased by providing improved discontinuous long reinforcing fiber polymer matrix composite flakes having modified edge features that create progressive ends.

### Description of Related Art

Articles formed from discontinuous long fiber composite materials are known in the art, and are generally formed from heat-molding processes of various types. The articles may be formed from continuous long fiber composite materials, e.g., rod stock, pellets, composite blocks and composite tapes, which may be pre-fabricated composites that can be chopped, re-molded to prepare feedstock shapes such as plates, flakes or varied particles, for use in forming the end product articles. Such feedstocks can be cut so as to have short or long fibers within the feedstock. One known composite feedstock material, reinforced flake, is formed by cutting, chopping or using waste portions of unidirectional tape or similar long fiber-reinforced continuous composites. Such composite tapes can incorporate reasonably high loadings of fiber and thus, the flakes formed from such tapes can provide a high fiber-loaded feedstock. Flakes may be cut so as to provide a discontinuous long reinforcing fiber flake. Once molded, the articles formed from such flake may include random distribution of discontinuous long fibers and likely also, if desired, of short fibers and/or a portion of long continuous fibers.

Various molding methods are known and can be modified to achieve varying results from such feedstocks including, for use in modifying properties and/or varying levels of random fiber orientation within the matrix polymer(s).

The advantages of using such unidirectional tapes as noted above for formation of flakes as a feedstock for use in forming an end product article, are the high fiber loadings that can be obtained, the good “wet-out” of the fibers by the matrix polymer, as well as a good degree of fiber distribution, low waste processing and the ability to create complex molding geometries that can approach those formed from injection molding. However, a disadvantage of discontinuous long fiber flake materials formed from such unidirectional tapes is that such flakes generally tend to result in articles that, while having good properties and generally random distribution, can have a tensile strength lower than desired. Typical values for discontinuous long fiber articles, e.g., in a polyarylene matrix, such as in a polyetherether ketone matrix, using carbon fiber as a reinforcing fiber are about 200 to about 220 MPa. There is a need in the art to attempt to enhance the strength of composites formed from chopped feedstock, and particularly those formed from discontinuous long fiber composite flake.

European Patent Application No. EP 3 421 207 A1 provides one prior art method to attempt to form articles of composites of discontinuous fiber-reinforced material. In the patent, a discontinuous reinforcing bundle incorporates a cut surface inclined at a predetermined angle with respect to the orientation direction of a single yarn and thus has different lengths of fiber bundles. Longer bundles incorporate a smaller tip angle at the end of the discontinuous fiber bundle. Such composites are used to form shaped products of discontinuous fiber-reinforced composite material that require high fluidity, two-dimensional isotropy and small variation in mechanical characteristics.

U.S. Pat. No. 6,251,809 describes a composite of discontinuous fibers wherein, in the warp and weft of the fabric pattern, the fibers are treated to adhere to the polymer matrix. A series of patterned cuts are made into the warp fibers.

U.S. Pat. No. 8,709,319 describes flakes for molding of thermoplastic articles that have fibers of differing lengths. The flakes may be formed from a roll of unidirectional tape which is cut into varied shapes and using varied fiber lengths.

U.S. Pat. No. 9,283,706 describes forming flakes for molding, which flakes may be formed of thermoplastic and discontinuous fibers. The flakes can be generally rectangular or other shapes, including ovals to provide fibers with varying lengths for more isotropic properties and to provide strength.

U.S. Pat. No. 10,160,146 teaches a method of molding using a feed stock of chopped or cut long fiber pre-preg material, which can include discontinuous long fiber, and is in the form of fabric, tape or rod reinforced with fiber. This material is fed to a first molding section in a single mold, wherein the first molding material has discontinuous long fiber reinforcement. The material is pushed through a port and molded in a mold section within the mold to provide more uniform molding parts that are strong due to enhanced fiber orientation.

U.S. Pat. No. 8,529,809 provides a description of formation of composite plates having layers arranged in varying directions to create a composite that is described by the patent as a quasi-isotropic panel. A cutting tool cuts and divides the composite to form quasi-isotropic flakes from the panel. Tooling such as lasers, saws or punches or other structures can be used to make squares, ellipses, circles, rectangles and triangles.

U.S. Pat. No. 5,151,322 describes composite plates formed from randomly-arranged strip pieces of unidirectionally-oriented reinforcing fibers that are cut from tape to increase strength in a quasi-isotropic manner.

U.S. Pat. No. 9,302,434 includes a moveable cylindrical mold for feeding flakes, which are described as having been formed from thermoplastic having fibers of carbon, glass or other materials that can be made by chopping unidirectional thermoplastic prepreg into desired sizes and shapes. While shown as rectangular, the patent mentions that the flakes can be other shapes.

U.S. Patent Publication No. 2013/0189478 A1 discloses use of narrow flakes of a ratio of at least 6:1 height to width to form composites of a consistent uniform strength.

U.S. Pat. No. 9,724,854 describes forming composites from chips formed from unidirectional tape using thermosetting resins. The chips are rectangular structure, but may be in other shapes depending on how the unidirectional tape is chopped.

Thus, while various sizes and shapes of flakes or chips have been used for forming various articles and while attempts have been made to improve the strength of the resulting articles and/or to provide more uniform properties in the articles, a need in the art remains to significantly enhance overall strength and property uniformity throughout articles formed from polymeric composite flakes, increase the impact resistance, particularly at high velocities, and increase the failure limit for articles formed from polymeric composite flakes. It would further be desirable to achieve such goals while using economical and low waste processes that employ composite flakes as a molding feedstock and while providing an easy to use apparatus for forming flakes.

### BRIEF SUMMARY OF THE INVENTION

The invention herein includes a method of forming a modified polymeric composite flake used in forming articles, articles formed from the resulting modified polymeric composite flake, modified polymeric composite flakes for use in forming articles and an apparatus for forming modified polymeric composite flakes.

In an embodiment herein, the invention includes a method of providing a modified polymeric composite flake for use in forming articles, comprising: (a) providing a composite having at least one polymeric matrix material and long reinforcing fibers of a first fiber material extending through the polymeric matrix material, and (b) forming from the composite at least one flake, wherein the at least one flake comprises an exterior surface having an exterior edge, a portion of the exterior edge being configured to provide at least one exterior edge feature to the exterior edge of the at least one flake thereby providing a modified polymeric composite flake.

The method may further comprise forming the at least one modified polymeric composite flake by cutting the composite to form the at least one modified polymeric composite flake. The at least one flake may be cut by a cutting device. The composite may be in a form selected, e.g., from a tape, a plate, and a sheet. The long reinforcing fibers within the composite may be unidirectional. The long reinforcing fibers within the composite may be continuous long reinforcing fibers. In another embodiment, the composite may be in the form of a tape and the long reinforcing fibers may be unidirectional continuous long reinforcing fibers. The long reinforcing fibers in the composite may be continuous long reinforcing fibers.

In a further embodiment of the method, the at least one exterior edge feature may have at least two angled sides. Such at least two angled sides of the exterior edge feature may be angled towards each other at an angle of about 5° to about 120°, about 20° to about 90°, about 20° to about 60° or about 30° to about 60°. In such an embodiment of the method the at least two angled sides of the exterior edge feature may also be contiguous and together form a vertex of the angle at a point of contact between the at least two angled sides.

In the method, there may be one, or in another embodiment, a plurality of exterior edge features. In such an embodiment having a plurality of exterior edge features, at least two angled sides of each exterior edge feature may be contiguous and together form a vertex of an angle at a point of contact between the at least two angled sides, and at least two of the exterior edge features in the plurality of exterior edge features may also be contiguous so that the portion of the exterior edge having the at least one exterior edge feature comprises a zig zag pattern. In the method, in a further embodiment, the exterior edge of the at least one modified polymeric composite flake may comprise at least three exterior edge portions, and at least two of the exterior edge portions may comprise the zig zag pattern.

In such embodiment, the long reinforcing fibers in the at least one modified polymeric composite flake may be unidirectional and extend through the at least one polymeric composite flake in a first direction and the exterior edge portion comprising the zig zag pattern may extend in a second direction that is at an angle with respect to the first direction. The angle between the second direction and the first direction may be about 90°, or about 60° to about 90°.

The at least one exterior edge feature in the embodiments of the method noted above may be configured to have a shape selected from a triangle shape (such as in the zig zag pattern noted above), but may also be, a parabola shape, a parallelogram shape, a bell shape, a bullet shape, an arrowhead shape and/or a trapezoid shape. When there are more than one exterior edge feature, each exterior edge feature may be the same or different. Further, when there are two or more exterior edge features, together the edge features may form a pattern. The at least one exterior edge portion may also in another preferred embodiment be shaped as a parallelogram such as a rectangle, e.g., to form a rectangular toothed configuration in a pattern form.

In the method, the at least one modified polymeric composite flake may have four exterior edge portions, two of which are opposing exterior edge portions, each of which opposing exterior edge portions may have a pattern formed thereon so that the pattern extends along substantially all of the two opposing exterior edge portions and so that a distance measured across the at least one modified polymeric composite flake longitudinally between the two opposing edge portions remains substantially the same throughout the pattern.

In the method as noted above, the polymeric matrix material may be a thermoplastic and is one or more of a polysulfone, a polysulfide, a polyimide, a polyaramid, a polyamideimide, a polyamide, a polyarylene polymer, a fluoropolymer, and combinations and copolymers thereof. The polymeric matrix material may further be a polyarylene polymer that is one or more of polyether ketones, polyetherether ketones, polyetherketone ketones, and combinations and copolymers thereof. The polymeric matrix material may be a fluoropolymer that is at least one of copolymers of tetrafluoroethylene and at least one perfluoroalkylvinyl ether; copolymers of tetrafluoroethylene and at least one other perfluorinated alkylene, polychlorotrifluoroethylene, ethyl chlorotrifluoroethylene, ethyltrifluoroethylene, polyvinylidene fluoride, polyvinyl fluoride, and combinations and copolymers thereof.

The long reinforcing fibers in the at least one modified polymeric composite flake used in the method may be one or more of inorganic fibers, ceramic fibers, glass fibers, graphite fibers, carbon fibers, and organic fibers which may be thermoplastic fibers or thermosetting fibers, and combinations thereof.

In one embodiment, the exterior edge of the at least one modified polymeric composite flake in the methods noted above defines, on the exterior surface of the at least one flake, a surface area having an overall shape that is generally a triangle, a polygon having at least five sides, a circle, a parallelogram or a trapezoid and the exterior edge features may be formed on at least one edge portion of such surface area shape. The surface area defined by the exterior edge may be a parallelogram selected from a square, a rectangle and a rhombus.

In another embodiment, there may be a plurality of modified polymeric composite flakes, each having a surface area defined on the exterior surface of the flake by the exterior edge of the flake and a thickness measured along the exterior edge of each flake in a plane orthogonal to the surface area of the flake, and wherein an average exterior surface area for the plurality of flakes is about 20 square millimeters to about 650 square millimeters and an average thickness of the plurality of flakes is about 0.05 mm to about 0.25 mm. In yet a further embodiment of the method, an average exterior surface area of the plurality of modified polymeric composite flakes is about 20 square millimeters to about 325 square millimeters. In a further embodiment an average exterior surface area for the plurality of flakes is about 150 square millimeters to about 170 square millimeters, and the average thickness of the plurality of flakes is about 0.1 to about 0.20 mm.

When an article is formed in the method noted above, using a plurality of the modified polymeric composite flakes having the exterior edge features, the article formed may have an average tensile strength that is at least about 30% greater, or may be at least about 40% to about 60% greater, than a tensile strength of an article formed using a plurality of the flakes formed of the same material, and having the same overall shape and size but that lack the exterior edge features.

The at least one edge feature in the method may have at least two angled sides, and wherein the at least two angled sides of each exterior edge feature on the at least one modified polymeric composite flake are contiguous and together form a vertex of an angle at a point of contact between the at least two angled sides, and there may also be a plurality of the exterior edge features on the at least one modified polymeric composite flake, with at least two of the angled features in the plurality of exterior edge features that may also be contiguous so that a portion of the exterior edge of the at least one modified polymeric composite flake comprises a zig zag pattern.

There may be about two to about twelve, and preferably about four to about eight of the exterior edge features in the zig zag pattern on the at least one modified polymeric composite flake. Further, the at least one modified polymeric composite flake may comprise at least three exterior edge portions, at least two of which have the zig zag pattern. In such an embodiment, there may be about four to about eight of the exterior edge features in the zig zag pattern.

The invention also includes in another embodiment, an article formed by heat molding or curing, depending on the matrix polymer, a plurality of the modified polymeric composite flakes formed by the method as described above. Such articles may be components, apparatus or parts for use in high temperature and/or high pressure end applications or for use in aircraft, medical device, robotics, automotive, semiconductor, or sports end applications. The article may further be a bracket, a cover, a fairing or a cabin sidewall attachment for use in an aircraft. The article may also be a containment shell.

The article may be formed by heat molding or curing the plurality of the modified polymeric composite flakes together with unmodified polymeric composite flakes that may be the same or different than the at least one modified polymeric composite flake that is formed by the methods herein. The unmodified polymeric composite flakes in such instance may incorporate the same polymeric matrix material and the same long reinforcing fibers as those of the at least one modified polymeric composite flake formed by the method herein.

The invention further includes, in another embodiment, a method of increasing one of more of an average tensile strength, a high velocity impact resistance, and fatigue resistance of articles formed from composite flakes having at least one polymeric matrix material and long reinforcing fibers extending through the polymeric matrix material, and wherein the composite flakes comprise an exterior surface having at least one exterior edge. The method may comprise providing a plurality of the modified polymeric composite flakes, wherein each of the modified polymeric composite flakes has an exterior edge feature along a portion of an exterior edge of the flake and forming the articles using a plurality of the modified polymeric composite flakes.

A further embodiment of the invention herein includes a modified polymeric composite flake for preparing articles, comprising: an exterior surface having an exterior edge thereon, wherein the exterior edge defines an exterior surface area on the exterior surface, the modified polymeric composite flake having a thickness along the edge extending in a direction generally orthogonal to the exterior surface area defined by the edge; a polymeric matrix material; long reinforcing fibers within the polymeric matrix material; and at least one exterior edge feature on a portion of the exterior edge of the flake.

The shape of the exterior edge feature of such modified polymeric composite flakes may be selected from a triangle shape, a parabola shape, a parallelogram shape, a bell shape, a bullet shape, an arrowhead shape, and a trapezoidal shape. There may also be more than one exterior edge feature on a modified polymeric composite flake, and each exterior edge feature may be the same. There may be two or more exterior edge features that together form a pattern.

The long reinforcing fibers in the modified polymeric composite flakes herein may be unidirectional within the polymeric matrix material. The modified polymeric composite flakes may be formed from a composite having unidirectional continuous long reinforcing fibers.

The exterior edge feature may have at least two angled sides angled towards each other at an angle of about 5° to about 120°, about 20° to about 90°, about 20° to about 60°, or about 30° to about 60°. In such an embodiment, the at least two angled sides of the exterior edge feature may be contiguous and together form a vertex of the angle at a point of contact between the at least two angled sides.

In another embodiment, there may be a plurality of exterior edge features, each having the at least two angled sides. The at least two of the exterior edge features in the plurality of exterior edge features may also be contiguous and form a vertex of an angle at a point of contact between the at least two angled sides. The at least two of the exterior edge features in the plurality of exterior edge features may also be contiguous so that the at least one portion of the exterior edge of each of the plurality of flakes having the exterior edge features may comprise a zig zag pattern. Each of the modified polymeric composite flakes may comprise at least three exterior edge portions, at least two of which have the zig zag pattern.

The long reinforcing fibers in each of the modified polymeric composite flakes may be unidirectional fibers and extend through the modified flakes in a first direction and the at least one portion of the exterior edge of each of the flakes comprising the zig zag pattern may extend in a second direction, and the second direction may be at an angle with respect to the first direction. In such case, the second direction may be orthogonal to the first direction, or the second direction may be at the angle of about 60° to about 90° with respect to the first direction.

In another embodiment of the modified polymeric composite flakes herein, the polymeric matrix material may be a thermoplastic and can be one or more of a polysulfone, a polysulfide, a polyimide, a polyamideimide, a polyamide, a polyaramid, a polyarylene polymer, a fluoropolymer, and combinations and copolymers thereof. The polymeric matrix material may also be a polyarylene polymer that is one or more of polyether ketones, polyetherether ketones, polyetherketone ketones, and combinations and copolymers thereof. The long reinforcing fibers in the composite may be one or more of inorganic fibers, ceramic fibers, glass fibers, graphite fibers, carbon fibers, organic fibers including thermoplastic fibers and thermosetting fibers, and combinations thereof.

In another embodiment of the modified polymeric composite flakes herein, there may be a plurality of exterior edge features on the modified flake, each of the exterior edge features may comprise at least two angled sides, and the at least two angled sides may be contiguous and together form a vertex of an angle at a point of contact between the at least two angled sides, and further, at least two of the exterior edge features in the plurality of exterior edge features may also be contiguous so that the at least one edge portion of the exterior edge having the exterior edge features on each of the modified polymeric composite flakes comprises a zig zag pattern. There may be about two to about twelve exterior edge features in the zig zag pattern, preferably about four to about eight exterior edge features in the zig zag pattern. The modified polymeric composite flake may comprise at least three exterior edge portions, at least two of which have the zig zag pattern. In such an embodiment, there may be about four to about eight exterior edge features in the zig zag pattern.

In yet a further embodiment of the invention, an apparatus is provided for forming modified polymeric composite flakes for use in forming articles, comprising: a feeder for controllably feeding a portion of a composite, the portion of the composite configured and sized to form a flake, the composite comprising at least one polymeric matrix material and long reinforcing fibers extending through the polymeric matrix material in the composite; and a moveable and controllable cutting device that operates as a guillotine to cut a portion of the composite fed by the feeder into a flake and comprising a one or more removable cutting templates configured for providing at least one exterior edge feature on a portion of an edge of a flake cut from the cutting device. In one embodiment, the apparatus may further comprising a controller for controllably operating the feeder and/or the cutting device. Different cutting templates may be used for providing different edge features to different edge portions of the cut flake.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a top plan view of a representative depiction of a prior art type of composite flake that may be used in embodiments of the method herein and that is used to make Comparative Samples in Examples 1, 2 and 3 herein;

FIG. 1A is side elevational view of the composite flake of FIG. 1;

FIG. 2 is a perspective representative depiction of an alternate flake that may be used in an embodiment of the method herein;

FIG. 3 is a top plan representative depiction of a modified flake having exterior edge features according to an embodiment hereof and made according to an embodiment of the method herein and which is used to make inventive Samples A, B and C in Example 1 herein;

FIG. 3A is a top plan view of an embodiment of the modified flake Sample 30-4 used in Example 2 herein;

FIG. 3B is a top plan view of an embodiment of the modified flake used in Sample 60-4 in Example 2 herein;

FIG. 3C is a top plan view of an embodiment of the modified flake used in Sample 90-4 in Example 2 herein;

FIG. 4 is a perspective representative depiction of the modified flake of FIG. 3;

FIG. 5A is a plan view of an embodiment of a modified flake in used in Example 2, Sample 30-8;

FIG. 5B is a plan view of an embodiment of a modified flake used in Example 2, Sample 60-8;

FIG. 5C is a plan view of an embodiment of a modified flake used in Example 2, Sample 90-8;

FIG. 6A is a plan view of an embodiment of a modified flake used in Example 2, Sample 30-12;

FIG. 6B is a plan view of an embodiment of a modified flake used in Example 2, Sample 60-12;

FIG. 6C is a plan view of an embodiment of a modified flake used in Example 2, Sample 90-12;

FIG. 6D is a plan view of an embodiment of a modified flake used in Example 2, Sample 5-12;

FIG. 6E is a plan view of an embodiment of a modified flake used in Example 2, Sample 15-12;

FIG. 7A is a plan view of an embodiment of a modified flake used in Example 2, Sample 6×2;

FIG. 7B is a plan view of an embodiment of a modified flake used in Example 2, Sample 6×1;

FIG. 8A is a plan view of an embodiment of a modified flake used in Example 2 as Comparative Sample D;

FIG. 8B is a plan view of an embodiment of a modified Flake used in Example 2 as Comparative Sample E;

FIG. 9 is a graphical representation of the average tensile strength (MPa) of articles formed from the modified flakes for the inventive Samples and Comparative Samples of Example 2;

FIG. 10 is a graphical representation of the average tensile strength in MPa of the articles formed from modified flakes of the inventive Samples and from the flakes in the Comparative Samples of Example 2 as a function of the depth in mm of any exterior edge features present, wherein the depth represents the length that was cut into the original composite flakes for an exterior edge feature;

FIG. 11 is a graphical representation of the tensile strength in MPa of articles formed from unmodified commercial polymeric flakes and from modified versions of the same commercial flakes as in Example 1;

FIG. 12 is a photographic image of a jig for mounting a composite plate test sample in the high velocity impact testing of Example 3;

FIG. 13 is a graphical representation of the impact speed of hail stones on the composite plates tested in Example 3 for the various Samples tested having a modified flake design as in FIGS. 3 and 4 and for a Comparative Sample formed in the manner of Comparative Sample D of Example 2;

FIG. 14 is a plan view of a modified flake configuration according to an embodiment of the invention having a pattern of triangular exterior edge features on edge portions of the flake, wherein contiguous exterior edge features are joined by a single point of contact and the edge features have angled sides meeting in a vertex;

FIG. 15 is a plan view of a modified flake configuration according to an embodiment of the invention having a pattern of parabolic exterior edge features on edge portions of the flake, wherein contiguous exterior edge features are joined by a single point of contact and the edge features have curved sides and meet at a terminal curve;

FIG. 16 is a plan view of a modified flake configuration according to an embodiment of the invention having a pattern of parallelogram exterior edge features on edge portions of the flake wherein the edge features are joined by a substantially linear edge portion and the sides are angled sides that are parallel to one another but joined at a terminal end by a connecting linear end;

FIG. 17 is a plan view of a modified flake configuration according to an embodiment of the invention having a curved pattern on edge portions of the flake, wherein contiguous exterior edge features are joined by a curved edge portion and the edge features have partly linear sides that are parallel but that curve toward each other at the terminal end of the edge features to form a semicircular end giving the exterior edge features the appearance of the end of a tongue depressor or a bell-shape wherein the bell sides are in part linear and parallel;

FIG. 18 is a plan view of a modified flake configuration according to an embodiment of the invention wherein an edge feature is provided on edge portions of the flake in the form of a triangle extending outwardly on one edge portion of the flake having a vertex and extending along the length of the edge portion and two half triangles extending outwardly (to define an inwardly extending triangle) on the opposite edge portion of the flake so that the fiber length remains substantially constant along the flake;

FIG. 19 is a plan view of a modified flake configuration according to an embodiment of the invention wherein the flake has a pattern provided on opposing edge portions of the flake that is formed from two different types of exterior edge features, one being a rectangle exterior edge feature (which has parallel sides and terminates in a linear end) and one being a bullet-shaped exterior edge feature (having curved sides that meet in a sharply curved end), the features are shown in an alternating pattern extending along a first exterior edge of the flake and also extending in a reverse pattern on the other opposing exterior edge of the flake so that the fiber length remains substantially constant along the flake and the alternating exterior edge features on each side are joined by a substantially linear edge portion;

FIG. 20 is plan view of a modified flake configuration according to an embodiment of the invention wherein an edge feature is provided on edge portions of the flake in the form of a single, fully curved feature extending outwardly on one edge portion of the flake in a convex manner and extending along the length of the edge portion and a concave curved feature outwardly (to define an inwardly extending curved feature) on the opposite edge portion of the flake with the fiber length remaining substantially constant along the flake

FIG. 21 is a plan view of a modified flake configuration according to an embodiment of the invention wherein the flake has a pattern formed on opposing edges of a flake, wherein the exterior edge features are “arrowhead” shaped exterior edge features in which the arrowhead shape is formed of a bottom rectangular portion and a terminal triangular portion, the sides of the terminal triangular portion meet in a vertex, and the rectangular portions of each exterior edge feature are connected by substantially linear edge portions. The pattern extends across a first exterior edge portion and a reverse pattern extends across the opposing exterior edge portion of the flake;

FIG. 22 is a plan view of a modified flake configuration according to an embodiment of the invention wherein the flake has a pattern formed of rectangular-shaped exterior edge features having parallel linear sides joined at a terminal end by a linear terminal portion, wherein the exterior edge features are joined by substantially linear edge portions;

FIG. 23 is a plan view of a modified flake configuration according to an embodiment of the invention wherein the flake has a pattern on opposing edge portions of the flake, wherein the exterior edge features are shaped in a “dovetail” manner and appear as isosceles trapezoids having angled sides and having a terminal end joining the angled sizes that is a linear terminal end and wherein the exterior features are joined by a substantially linear edge portion;

FIG. 24 is a photographic representation of an apparatus for forming modified flakes according to the method herein;

FIG. 24A is a photographic representation of two removable cutting templates for use in the apparatus of FIG. 24;

FIG. 25 is a graphical representation of peak stress (MPa) against number of cycles from fatigue testing data of specimens in Example 4 formed from Comparative Sample X (composite formed from unmodified flake formed according to Example 1) and Inventive Sample Y (composite formed from modified flake formed according to Example 1); and

FIG. 26 is a graphical representation of the type of damage created by high velocity hail stone impacts on the composite plates tested in Example 5 formed from the composite of Comparative Sample X and Inventive Sample Y of Example 4 and a composite Inventive Sample Z formed from a modified flake design of a rectangular shape providing longer fibers in the length direction and the same edge modifications as Inventive Sample Y on the width direction edges of the modified flake.

### DETAILED DESCRIPTION OF THE INVENTION

In the description herein, words like “inner” and “outer,” “upwardly” and “downwardly,” inwardly” and “outwardly,” “exterior” and “interior,” “right” and “left,” “upper” and “lower,” “distal” and “proximal” and words of similar import refer to directions in the drawings for assisting in clarifying the features of the invention unless otherwise specified.

The invention includes a method of providing a modified polymeric composite flake for use in forming articles, modified polymeric composite flakes and articles formed therefrom having enhanced tensile strength, increased impact strength especially in high velocity impact situations and an increased failure limit as well as an apparatus for preparing modified polymeric composite flakes.

The modified polymeric composite flakes herein may be formed from a variety of flakes of varying types cut, stamped, molded or otherwise formed from a composite. The composite, in embodiments herein, is formed of a polymeric matrix material that includes at least one type of long fiber formed of a first fiber material. Such flakes may also be purchased commercially or independently formed and then provided for use in the method herein.

If forming the flakes from a composite, the composite is preferably a pre-formed composite having long reinforcing fibers extending within the composite, taken either from individual fibers, tows, braids or bundles. The composite may also be formed from a woven reinforcing fiber incorporated in a polymer matrix material, or using unidirectional long reinforcing fibers that can extend through a polymer matrix material. In preferred embodiments, the fibers are unidirectional and are preferably long reinforcing fibers. The long reinforcing fibers may be continuous or discontinuous. Similarly these same types of reinforcing fibers useful for making a composite that can be used to provide flakes to the method herein, are also preferably the same as those in the flakes provided by the method herein. Further, the same polymeric matrix material used to form a composite is preferably the same polymeric matrix material in the flakes provided by the method herein.

The long reinforcing fiber and the same first fiber material in such reinforcing material in the modified polymeric composite flakes herein may be a single type of fiber material or a blended material, i.e., more than one type of fiber material may be used in combination as a reinforcing long fiber material for impregnation, addition to or for otherwise receiving application of the polymeric matrix material to substantially wet such long reinforcing fiber to form composite materials and for ultimately also then forming the modified polymeric composite flakes provided herein from such composite materials.

Examples of suitable long reinforcing fiber materials (“first fiber material”), include, for example, without limitation, various long reinforcing fibers that are inorganic fibers such as ceramic fibers, glass fibers, graphite fibers, carbon fibers, quartz fibers, alumina fibers, silicon carbide fibers, basalt fibers, boron fibers, and combinations thereof such as glass/carbon, glass/graphite/carbon, graphite/carbon, and ceramic/glass. Further organic fibers, such as thermoplastic and thermosetting reinforcing long fibers, may be used, having first fiber materials such as aramid fibers, polybenzoxazole fiber, and the like, which may be used alone or in a blend with glass, ceramic or carbon fibers.

In fiber blends or combined fibrous reinforcements, additional fibers may be provided in the form of chopped strands, filaments or whiskers to the fiber matrix prior to impregnation. Further, such blends may include bundles, tows and braids extending in a long fiber direction and/or various woven or blended fibrous materials extending in more than one direction to provide strength and/or other desired properties.

Preferred long fiber materials include ceramic, glass, graphite, carbon, and/or plastic (thermoplastic and thermoset) fibers (such as aramid fiber (available as Kevlar®, Twaron® and Technora®) or polybenzoxazole fiber available as Zylon®)).

The long reinforcing fibers may be unidirectional or bi-directional continuous or discontinuous fibers (preferably bidirectional fibers would have approximately 50% of the fibers in the parallel direction and approximately 50% of the fibers in the perpendicular direction), stretch-broken, braided fibers and woven continuous fibers. Preferably the reinforcing fibers are unidirectional. Additionally, the reinforcing fibers may be braided or commingled fibers. Preferred diameters for the long reinforcing fibers, depending on the fibers chosen, typically include about 0.1 microns, about 5 to about 15 microns, and about 7 to about 10 microns. Boron fibers may range from 100 microns to about 140 microns, and glass fibers may range from about 5 to about 25 microns. Basalt fibers may range from about 10 to about 20 microns.

It is preferred that the long fiber reinforcement is about 30% or more, preferably 40% or more, more preferably 50% or more, e.g., may be about 60% to about 90% by volume of a composite used to form the modified polymeric composite flakes provided herein with respect to the total volume of the composite. It is preferred that the long fibers are about 40% to about 80% by volume of the composite, and most preferred that they are about 50% to about 70% by volume of the composite, with the understanding that different fibers having different diameters may make the preferred volume higher or lower.

The long reinforcing fibers used in the composite materials used for providing modified polymeric composite flakes herein can be incorporated into a composite, such as a long fiber-containing pre-preg or other impregnated composite structure, through any suitable techniques known or to be developed in the art, provided that the resulting structure is suitable for use in forming the polymeric composite material for use in forming articles herein. It is also within the scope of the invention herein that modified polymeric flake materials herein may also be formed by a direct shaping such as by molding or stamping a long reinforcing fiber-containing composite into modified flake form.

In one preferred embodiment herein, a continuous long reinforcing fiber structure may be used, such as an impregnated continuous fiber tape, plate, sheet, fabric or the like. As used herein, continuous fibers in such structures are those which generally have a length of at least about 0.20 in., and in embodiments herein at least about 0.5 in. (1.27 cm). Lengths of at least 0.5 in. allow for a combination of easy processing and good resulting properties. While longer fibers are known to typically yield better mechanical properties, processing is not always easier. Thus, one skilled in the art would understand that fiber length can be selected to balance the mechanical properties and processing conditions for a given process. Such structures or other continuous fabric tape, plate, sheet, rod stock or the like may be cut, chopped, stamped or otherwise formed to various sized composite flakes but preferably retain some or a large portion of their original long reinforcing fiber length such that the flakes are preferably discontinuous long fiber flakes. Examples of such structures that are preferred for forming modified polymeric composite flakes for use in the method herein are those that have reinforcing long fibers having a length to diameter ratio of greater than about 100.

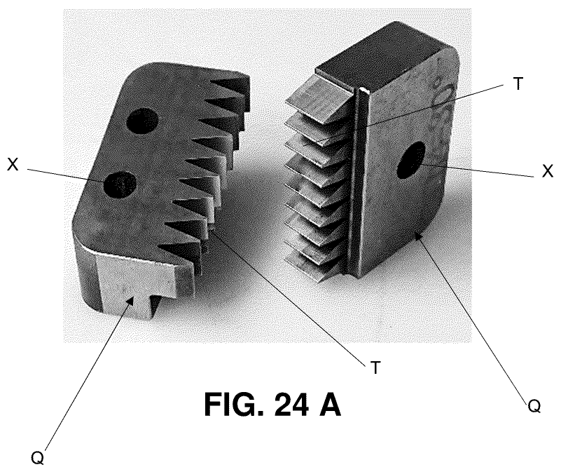

Such continuous long reinforcing fiber composite structures are then cut by a cutting device, chopped, stamped, die-cut or otherwise formed into the modified polymeric composite flakes herein. In one preferred embodiment herein, an apparatus A shown in FIG. 24 herein is provided for forming flakes for use in forming articles. In the apparatus A, a feeder D controllably feeds a portion of a polymeric composite, shown as a polymeric composite unidirectional tape E, towards a cutting device G. The portion of the composite fed is configured and sized to form a flake and so may be set for a particular sized flake. If a one-half inch flake is to be used and then modified according to the present invention, then the feeder D can feed 0.5 in. portions to the cutting device G. The composite may have a polymeric matrix material and long reinforcing fibers extending through the polymeric matrix in the composite which may be according to any of the embodiments described elsewhere herein. The feeder D can be controlled by a motor-driven feed controller J set for a particular size flake.

The cutting device G is moveable preferably in reciprocating manner so as to cut across the composite tape. Depending on the design or orientation of the cutter, it may be an up and down stroke cut or a left to right stroke cut. As shown, a guillotine type blade GB is positioned centrally within the cutting device G to cut composite tape E as is passes through a cutting area in the center of the cutting device. The controllable cutting device may be set to operate at a certain interval speed for cutting edge features into the portion of the composite tape as it passes through the device. For example, as shown, while the guillotine-type blade (GB) is open so that the templated plates (described below) are apart, the motor ‘J’ drives a roller to move the composite tape forward by a length corresponding to the desired or set flake length. The tape movement stops, and at that moment, the guillotine type blade GB pushes downwards to cut the tape, and then the process repeats. Thus, G works as a camshaft, synchronized with the movement of motor J. As such, G includes a cutting blade (GB) that is also synchronized with the movement of motor J. As the composite tape is cut, e.g., with a zigzag cut, the guillotine type blade (GB) lifts up and opens again for the next section of tape moved forward by the operation of the motor J. Thus, the motor J movement of the tape so that it moves forward in a synchronized manner enables formation of flakes from the composite tape, and the cutting pattern selected may be repeated at every cut in each desired flake length.

The cutting device G includes one or more removable cutting templates Q shown in FIG. 24A that are configured to be installed within the cutting device in a removable manner using any suitable fastener or pin. As shown, fastener openings X are provided on the templates Q for securing the templates within the device. The templates may be made to have varying cutting teeth T for providing the at least one exterior edge feature(s) to one or more portions of the edge of modified flakes formed while cutting the composite tape using the cutting device G.

As shown cutting templates Q are provided with teeth T, such as by machining or other tool manufacture, so that the teeth T as shown may provide the desired edge features. In the example template Q shown in FIG. 24A, the template can provide triangular exterior edge features into opposing edges of a flake while it is simultaneously cut from a unidirectional tape such that the modified polymeric composite flake may be cut and the features provided simultaneously within the same cutting device G. It should be understood by one skilled in the art, however, based on this disclosure that a variety of templates Q may be crafted to cut into flakes in the cutting device different exterior edge features and the templates exchanged for different cuts in a modular fashion. Further, it should be understood that any cutting method to form reinforced long fiber flakes from a composite having long fiber, which may be continuous long fiber, is within the scope of the invention, including the cutting process noted above, die-cutting, manual formation or direct formation such as by heat molding of pre-sized flakes.

The apparatus may further include a built-in or independently operable controller for controllably setting and operating the feeder and/or the cutting device. Control, such as numerical control, of the above-noted cutting device G, may be used to control the operation of the motor J that advances a composite tape as well as to control the motor that drives the camshaft in cutting device G and hence also controls the position of the guillotine type blade(s) (GB). While the apparatus A is shown for use in forming the modified polymeric composite flakes of the Examples herein, it may be formed in a larger industrial scale with a variety of feeders and cutting devices with interchangeable or fixed cutting templates.

Modified polymeric composite flakes herein may be of a variety of sizes and shapes as discussed further herein. In addition, composites used to make commercially available flakes may also be used in the method herein for providing modified polymeric composite flakes. In the composites used as feedstock, the long fibers may remain continuous long fibers in the resulting modified polymeric composite flakes or the modified polymeric composite flakes used may be formed from or cut so as to include discontinuous long fibers. Commercially available flakes may also be combined with modified polymeric composite flakes formed herein to prepare articles, wherein such differing types of flake are mixed together prior to molding or otherwise heat forming articles.

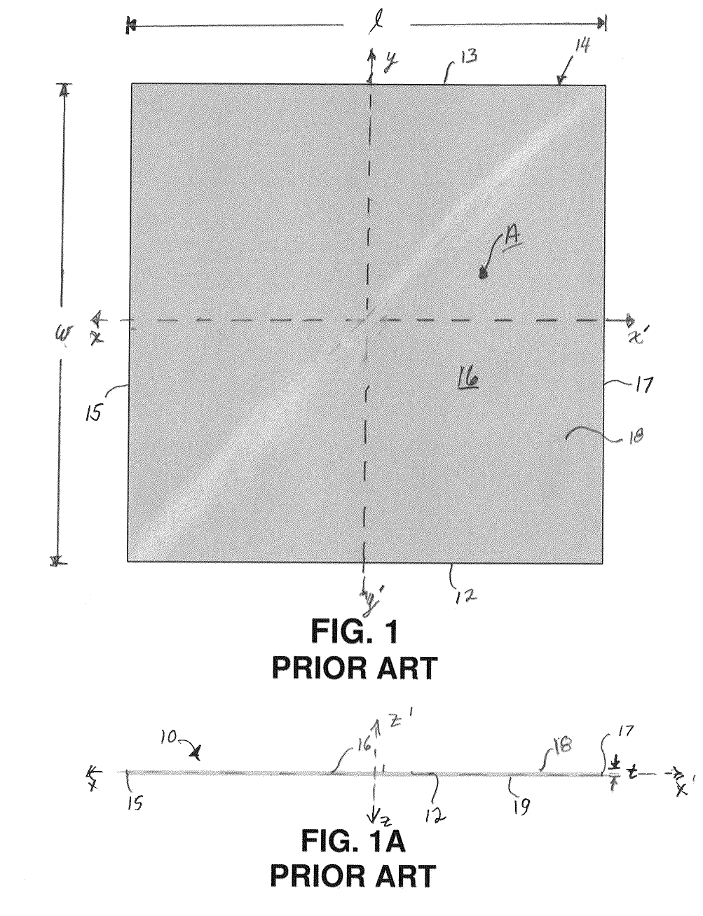

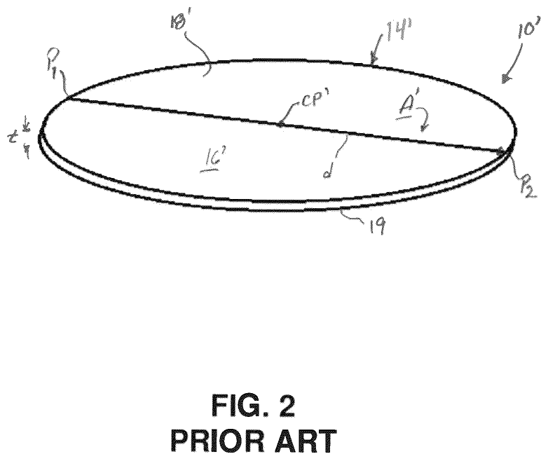

With reference to FIGS. 1 and 1A, standard polymeric composite flakes as referenced herein, when used with modified polymeric composite flakes according to the method, that is, commercial composite flakes that are not modified, may be represented generally with reference to an example of a polymeric composite flake 10, having a length l extending in along a longitudinal axis x-x′ through the flake and a width w measured orthogonally to the length l and extending along a transverse axis y-y′, or if circular, as shown in an alternative commercial type unmodified flake 10′ in FIG. 2, such a flake may have a diameter d. If the flake is square, the length l and the width w would necessarily be the same. It is noted that corresponding reference numbers herein are used for analogous features in the flakes of FIGS. 1, 1A and 2.

Each of such measurements, width and length (or diameter) are measured between respective opposing exterior edge portions 12, 13 (defining width) and 15, 17 (defining length) of a perimeter, referred to also herein as the exterior edge 14. The exterior edge 14 defines a surface area A on an exterior surface 16 of each flake. Preferably the surface area A is generally planar as with most manufactured flake, but of course may be somewhat irregular or non-planar if desired. The surface area A in the prior art embodiment shown has a first surface area 18 on one face of the flake and a second opposing surface area 19 on an opposite side of the flake, each is typically and preferably of the same or a similar size. As flakes are typically very thin, and almost two-dimensional in character, the surface areas 18, 19 are typically the same. The exterior surface 16 extends around the entirety of the flake encompassing the first and second opposing surfaces 18, 19 and the edge portions 12, 13, 15 and 17 of the flake that define the shape of the opposing surfaces 18, 19 and which provide a thickness t to the flake which extends along the z-z′ axis between the two opposing surfaces 18, 19.

In the flake of FIG. 2, the diameter d is measured by a straight line extending from a first point P1 on the circumferential edge 14′ through the center point CP′ of the area A′ and extending across the area A′ to the furthest point P2 from the starting point on the edge 14′.

It should be understood that the generally planar area A, A′ on the flakes may be planar, substantially planar or only partially planar, and may or may not include surface roughness or features extending from the opposing surface areas 18, 19 of the flake. The length and width may be the same or different. Further, shapes may be somewhat irregular.

Flakes also generally include a small but measurable thickness t, t′ measured orthogonally to the length l and width w (or diameter d) along an axis z-z′ through the flake from one opposing first surface area 18, 18′ to the other opposing second surface area 19, 19′. It is preferred that the thickness t is less than either of the length l and width w (and t′ is less than diameter d). Preferred commercially formed prior art flakes that may be used with modified flakes formed herein or that are of a similar size and shape, have a shortest dimension (l, w or d) on either of the opposing first and second surface areas 18, 19 (18′, 19′) that is larger than the corresponding thickness t, t′ of the respective flake.

While these parameters are illustrated with respect to square and circular prior art flake examples, it should be understood that other shapes and geometrical measurements may apply as are generally known, and further that thicknesses of commercially available flake, including flakes that may be used with modified flakes formed herein may be varied.

Flake thickness is important with respect to tensile strength. A thickness of about 140 microns is standard for most beneficial commercial flake product. Thin composite tapes may be obtained commercially at around 44 microns thickness, but such tape is significantly more expensive than standard composite tapes. To lower production cost, composite tapes are produced in thicker versions of about 250 microns and even as thick as 2,000 microns.

In manufacturing flakes from such composite tapes and similar composites, the narrowest (l or w) commercial flakes are typically around 1/16 in. wide (about 1588 microns). Flakes as large as 1 in. in length and/or width are also available but are not common. Such flakes may be used for forming larger composites parts. The smallest length or width is about 0.20 to 0.25 in., while other commercial flakes may be about 1 in. or 2 in. in length or width.

In preferred embodiments, modified polymeric composite flakes provided by the method herein having exterior edge features are about 1 in. in length and/or width or about 0.5 in. in length and width with an overall square configuration (aspect ratio of 1:1) as most preferred (wherein such dimensions are measured from one edge portion to the edge portion longitudinally or transversely across the flake). However, other aspect ratios of 1:16 and other shapes are contemplated for use within the invention herein.

Modified polymeric composite flakes provided by the method herein for forming articles, may be cut or otherwise formed into a variety of shapes, including shapes that are generally triangular, circular, polygonal (preferably having five or more sides), trapezoidal or a parallelogram such as a square, rectangle or rhomboid shape. By “generally” having a shape or having an “overall shape”, it is meant that the flakes, when viewed in a top or bottom plan view, have an exterior edge or periphery defining an area on opposing surfaces 118, 119, which area has an overall shape configuration encompassed by viewing a perimeter of the modified polymeric composite flake at the outer portion of its exterior edge 114, or in the case of a circular flake, a circumferential exterior edge 114′. The shape may or may not be, e.g., a perfect triangle, circle or parallelogram, etc., but the shape refers to the geometrical designation that best approximates the overall shape of the area(s) noted as seen in a two-dimensional manner without reference particularly to the exterior edge features formed in one or more portions of the exterior edge as described further below. In most preferred embodiments, the modified polymeric composite flakes have an overall shape that is generally square, rectangular or rhomboid in configuration.

With reference to a standard commercial flake 10 and FIG. 1, an average surface area, determined by the measurement of opposing areas 18, 19 over a plurality of the flakes and averaged over such plurality thereof, may be about 20 mm² to about 650 mm², with an average thickness of preferably about 0.05 mm to about 0.25 mm. Similarly sized flakes may also be cut from a composite to form modified polymeric composite flakes herein. In a more preferred embodiment, the average surface area may be about 20 mm² to about 325 mm², or about 150 mm² to about 170 mm², and the average thickness of about 0.1 mm to about 0.20 mm. One skilled in the art would recognize based on this disclosure that such sizes may be varied for different purposes and effects. Such ranges also would be recognized to encompass further ranges within the parameters hereof.

The polymeric composites from which commercial prior art flakes, as well as the modified polymeric composite flakes provided by the method herein, are defined by a fiber area weight content, e.g., 150 g/m², and a resin content, e.g., 32% by weight of polymer such as PEEK. Knowing the density of the fiber, e.g., carbon fiber having a density of 1.78 g/cm³, and that the density of the polymer, e.g., PEEK having a density of 1.30 g/cm³, this information conveys that the tape thickness in such instance is 139 microns, calculated as: 150*(1/1.78+(0.32/0.68)/1.3)=139. Other commercial suppliers of composite tape provide tape with the thickness indication and resin content. Flake thickness for commercial flake, as well as for modified flakes provided herein, will be the same as tape or other composite thickness from which the flake is cut.

Existing commercial composites that may be used to form the modified polymeric composite flakes herein may be obtained from Solvay in thermosetting and thermoplastic forms, including phenolic polymers, epoxy polymers, polyetherimides, with reinforcing long fiber, e.g., APC™ PEKK or PEEK reinforced tapes with unidirectional carbon fibers, KetaSpire® glass- and carbon-fiber reinforced flake materials; from Celanese Corporation, as Celstran® CFR composite tapes with unidirectional fibers and including various thermoplastics, including polyolefins, polyamides, and polyphenylene sulfides; from Evonik Corporation, e.g., Vestape® UD Tapes including PEEK matrix polymer and long carbon fiber; from Greene, Tweed & Co., as Xycomp® DLF® which includes flakes formed from carbon fiber and thermoplastics including PEEK; from SABIC Corporation in the form of thermoplastic composite tapes such as polyolefin and polyamides with glass and carbon fiber; and from Toray Industries as Cetex® TC1200 and related products provided as unidirectional carbon-fiber reinforced polymers such as epoxy polymers and PEEK. Such examples are not intended to be limiting. In preferred embodiments, carbon fiber/PEEK composites can be used in unidirectional tape form from which discontinuous long fiber modified flakes may be cut. Such tapes are available, e.g., from Solvay, Toray Industries, Inc. Suprem S.A., Barrday, Inc., Toho Tenax (Teijin, Ltd.) and Victrex plc.

While commercially available composites may be used, pre-pregs such as tapes with fiber reinforcements may be formed in situ at the same time and/or in the same location in which the modified polymeric composite flakes are to be cut in accordance with the methods herein. They may be formed by cutting, stamping, die-cutting or otherwise shaping a composite into the modified polymeric composite flakes herein having a polymeric matrix material and long reinforcing fibers such as those noted above.

Matrix polymers may be thermoplastic or thermosetting materials. Preferred thermoplastics for use in the composites and flakes herein as polymeric matrix materials herein include polymeric plastics and resins that can be loaded or filled with reinforcement, and that can flow under application of heat. Exemplary thermoplastics include, but are not limited to: polyolefins (such as polyethylene, polybutylene, polypropylene, high-density polyethylene), poly(acrylonitrile-butadiene-styrene)(ABS), polystyrenes, polybutadiene, polyacrylonitrile (PAN), poly(butadiene-styrene) (PBS), poly(styrene-acrylonitrile) (SAN), polybutylenes, cellulosic resins (such as ethylcellulose, cellulose acetate, cellulose acetate butyrate, cellulose acetate propionate, and cellulose nitrate), polyethylene vinyl alcohols (EVA), polyethylene vinyl acetates, fluoropolymers (such as melt-processible fluoroplastics, including copolymers of tetrafluoroethylene (TFE) and at least one perfluoroalkylvinyl ether (PAVE) (PFA), copolymers of TFE and at least one other perfluorinated alkylene (such as hexafluoropropylene) (FEP)), poly(chlorotrifluoroethylene), polyethyl chlorotrifluoroethylene (ECTFE), polyethyltrifluoroethylene (ETFE), polyvinyl fluoride (PVF) and polyvinylidene fluoride (PVDF)), ionomers, liquid crystalline polymer (LCP), polyacetals, polyacrylates, polyamides (such as NYLON 12, NYLON 6), polyphthalimides, polyimides, polyetheramides, polyamideimides, polyphenols, polycarbonates, polyesters, thermoplastic polyurethanes, polyvinylchlorides (PVC), polyvinylidene chlorides, polyvinyls, polyphenylene oxides (PPO), polyphenylene ethers, polyphenylene esters, polyphenylene ether esters, polyphenylene sulfides, polysulfones, polymethylpentenes, polyketones, polyarylene ether ketones, polyarylene ethers and polyaryl ether ketones (such as polyetherketone (PEK), polyetherketoneketone (PEKK) and polyetheretherketone (PEEK), polyethylene chlorinates, polyaramids, and thermoplastic biscitraconicimides.

Matrix materials may also include thermosetting materials including certain elastomers (such as ethylene propylene diene monomers (EPDM), ethylenepropylene rubber (EPR) and thermosetting polyurethane elastomers), epoxy resins, thermosetting biscitraconicimides (BCI), bismaleimides (BMI), bismaleimide/triazine/epoxy resins, cyanate esters, cyanate resins, furanic resins, phenolic resins, urea-formaldehyde resins, melamine-formaldehyde resins, phthalocyanine resins, polybenzoxazole resins, acetylene-terminated polyimide resins, silicones, polytriazines, thermosetting polyvinyl esters, thermosetting polyurethanes, polytetrafluoroethylene, melamines, polyalkyds, and xylene resins. Such polymers may be used alone, or in the form of various co-polymers or combinations thereof, where combinations may include mixtures, alloys, blends, and crosslinked combinations of one or more of such polymers and/or one or more of their copolymers.

Co-polymers (polymers formed of two or more monomeric species in random or block form, or graft copolymers, any of which may have multiple monomeric components or reactants) of each or any of these thermoplastics may also be used, whether known or to be developed.

In addition, such thermoplastics, provided they are still useful for forming a modified flake or a composite (or combination of composites) for forming such modified flake that by cutting the composite into the modified flake, may be further derivatized and/or include functional groups (whether terminal and/or on the chain), branched and/or straight chain backbone structures, additional locations of unsaturation along the chain or side groups, and the like. Functional groups which may be provided include aryls, ketones, acetylenes, acid groups, hydroxyl, sulfur-containing groups, sulfates, sulfites, mercapto, phosphato, carboxyl, cyano, phosphite, halogens, oxygen/ether or esters (also can be incorporated within the chains or side chains), carboxylic acid, nitric, ammonium, amide, amidine, benzamidine, imidizole, and the like.

While these polymers are preferred, the list should not be considered to be exhaustive, and one skilled in the art would understand based on this disclosure that other thermoplastics could be used in the invention without departing from the scope thereof.

Preferred materials from those noted above include engineering plastics such as polysulfones, polyimides, polyamideimides, polyetherimides, polyamides, polyphenylene oxides and sulfides, and the polyarylene materials, such as PEEK, PEK, PEKEKK, and PEKK. Fluoropolymers as noted above may also be used as preferred materials, provided they can be formed into composite to make modified flakes herein with reinforcing long fibers, and are flowable at a processing temperature for forming articles from the modified polymeric composite flakes.

Modified polymeric composite flakes may be formed from composites of the various polymers and long reinforcing fibers as noted above, but more than one type of composite may be provided such that mixed modified flakes or modified flakes formed of varying composites (or from mixed thermoplastics and/or reinforcing fiber materials) may be employed together and/or mixed with existing commercial flake when forming articles.

The composite for providing modified polymeric composite flake herein, may be formed solely of the reinforcing long fiber(s) and polymeric matrix material, or may have one or more additives provided thereto including other fillers and/or reinforcing agents known in the art or to be developed therein. Various additives used may include other types of reinforcement fiber or fillers and additives such as pigments, dyes, glass beads or spheres, carbon nanotubes, ceramic, mesh, honeycomb, mica, clay, organic colorants, plasticizers, thixotropic agents, flame retardants, UV absorbers, extenders, stabilizers, silicon dioxide, silica, alumina, talc, short glass fibers, barium sulfate, PTFE short fibers, TFE copolymer short fibers, other reinforcing fibers of varying lengths, ribbons or platelets, wollastonite, titanate whiskers, compatibilizers, rheological or thixotropic agents, antistatic agents (which may also be incorporated through use of functional groups and/or graft copolymers provided to the thermoplastic matrix), chopped or short carbon fibers, and other similar fillers, tribological additives and reinforcing agents. It is preferred that such additives (over and above the presence of the thermoplastic matrix material and the reinforcing material in the composite) be present in an amount no greater than about 10% of the composite based on the total weight of the composite (i.e. the total weight of the matrix fiber and long reinforcing fiber), however, more or less may be used depending on the intended end application. Preferably, such additives are not present or limited in use.

In the method herein, if the modified polymeric composite flakes are formed from one or more composites, once the composite(s) is/are provided, the modified flakes may be formed by cutting, stamping, or chopping the composite to form and provide one or more modified flakes. This procedure may be done prior to acquiring the flakes for use in the method, e.g., if composites are commercially purchased from a manufacturer prior to cutting or otherwise forming modified flakes herein, or procedures may be used for forming a composite and then cutting the composite at the same time the shape of the modified flake is formed and/or in the same location. That is, it is possible to prepare a cutting, chopping or other forming process that uses the composite(s) to form modified polymeric composite flakes. In addition modified polymeric composite flakes may be cut from a polymeric composite feedstock such as a unidirectional tape and modified using a cutting apparatus such as that described herein and shown in FIG. 24. The cutting may be done in a separate operation (creating a certain stock of modified flakes can be prepared and weighed in a chosen quantity to fill, e.g., a mold cavity) or, for example, while filling a mold, flakes can be cut and modified so as to fall directly into the mold.

The modified polymeric composite flakes from the method herein are provided by cutting or otherwise forming at least one exterior edge feature on a portion of the exterior edge of the flake. Depending on the configuration of the modified polymeric composite flake desired, it may have various exterior edges that may or may not be orthogonal to one another. The exterior edge features may be formed on the entire exterior edge, one or more edge portions (or partially or fully extending along some or all edge portions of the flake).

In embodiments herein, modified polymeric composite flakes may be formed having exterior edge features that have at least two sides, which may be linear or angled sides or having curved edge features on the edge of the exterior surface of the flake(s) and preferably on at least one portion of the exterior edge of the flake(s).

The exterior edge features may be made with any suitable cutting device, including a pair of scissors, shears, a knife, an automatic chopping device, a die-cutting machine, a saw, a cutting blade, a drill, a grinder, an abrasive waterjet, and a laser beam cutting device as well as the device described herein and shown in FIG. 24. It is also possible to use composite materials to form modified polymeric composite flake(s) herein having the long reinforcing fibers and matrix materials described herein. If desired, roughing the surfaces once the edge features are formed may also be provided for modifying edge properties.

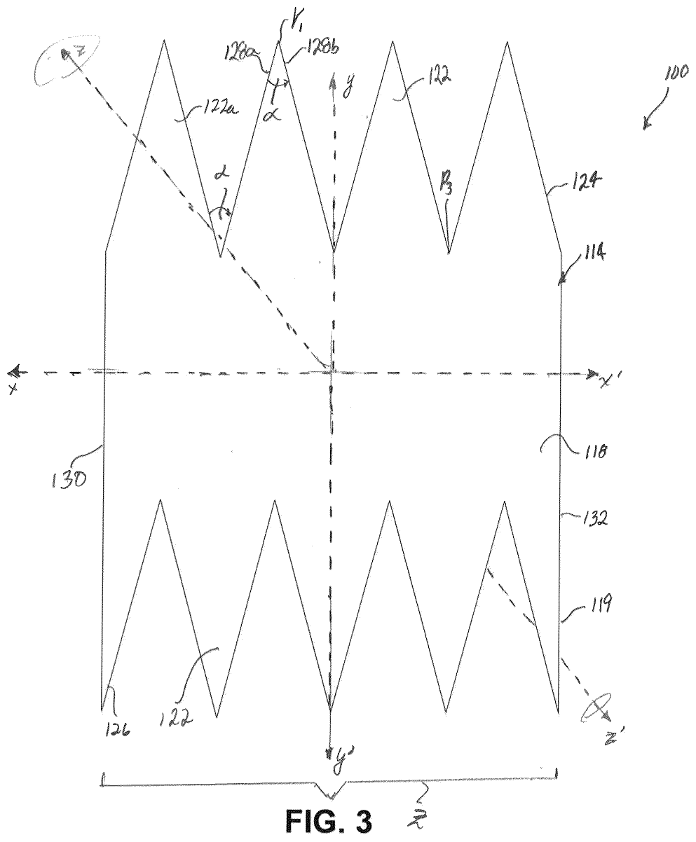

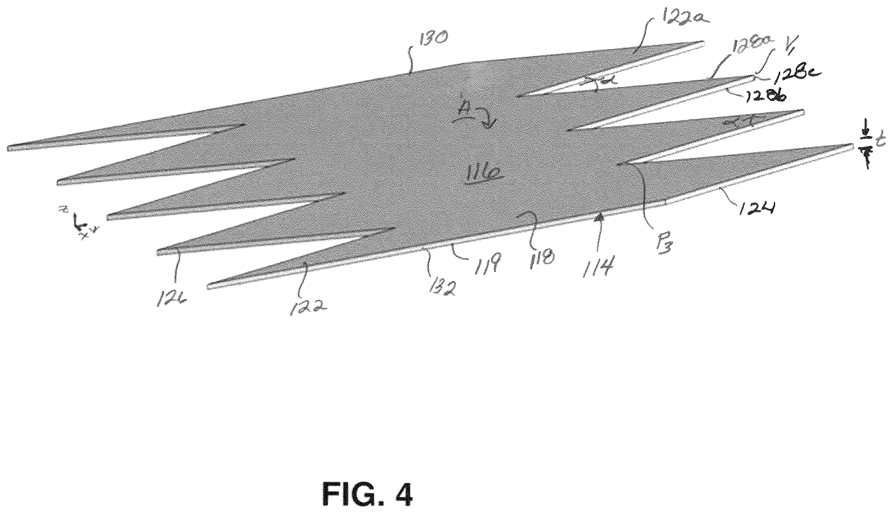

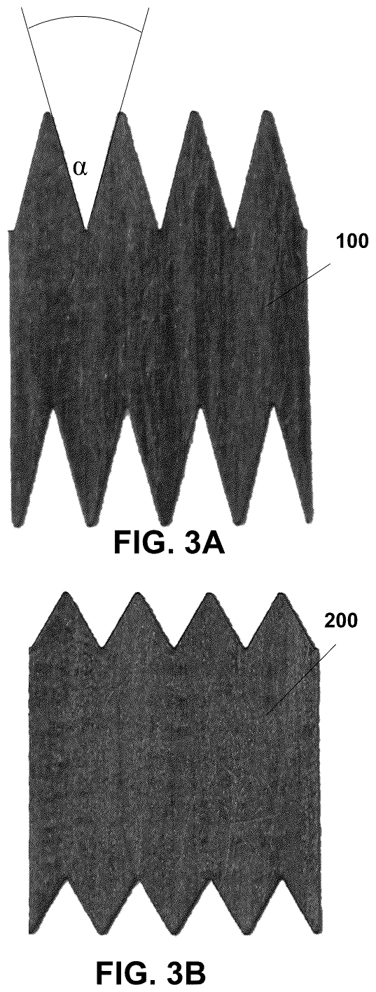

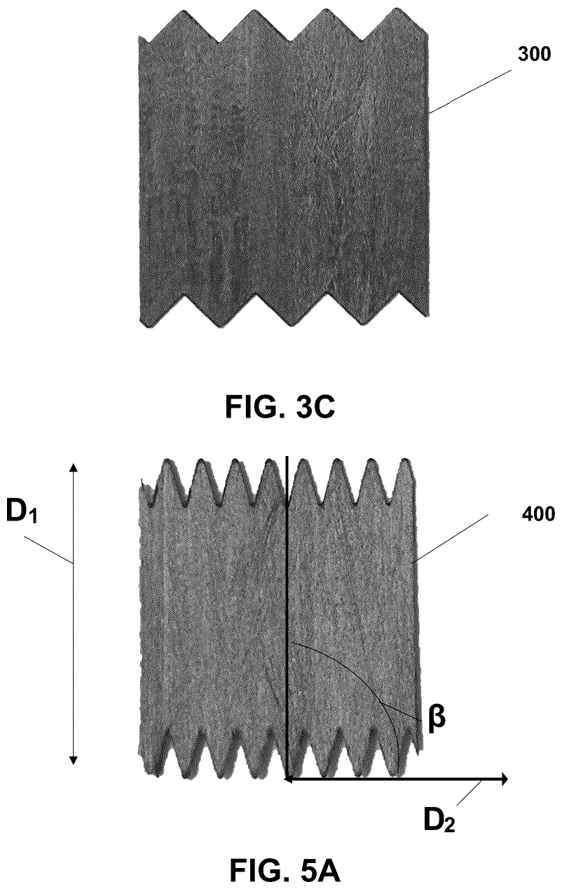

In some embodiments herein, angled sides of the exterior edge features may be preferably formed so as to be angled towards each other on one end of the angled end feature. FIGS. 3 and 4 provide a representation of a modified polymeric composite flake 100 herein having an exterior edge 114 defining a surface area A. Opposing exterior surface areas 118 and 119 appear on opposing sides of the modified polymeric composite flake 100. Exterior edge features 122 are formed on the exterior surface 116 of the modified flake on a first edge portion 124 of the modified flake forming an extending shape that is triangular in plan view. Similar exterior edge features 122 are formed on a second edge portion 126. As shown, the second edge portion is an opposing edge portion. Angled sides 128a, 128b which apply to each of the exterior edge features as shown define the shape of each of the exterior edge features (here shown as all the same and having an outwardly extending triangle shape).

The angled sides 128a, 128b illustrated in FIGS. 3 and 4 form a first exterior edge feature 122a. The angled sides 128a, 128b are angled with respect to each other and form an angle a having a vertex. The angled sides 128a, 128b as shown in this embodiment are contiguous and meet at a point of contact 128c to form the vertex V₁ of the angle α at the outermost tip of the triangular-shaped exterior edge feature 122a. Because each of the features is the same and each exterior edge feature is also contiguous, the angle α, also represents the angle between the exterior edge features extending toward one another. The contiguous features connect to one another at a single contact point P₃ (which is the vertex of the inwardly extending end of the exterior edge feature). Angle α is preferably acute as shown in FIGS. 3 and 4. In embodiments herein, angle α may range from about 5° to about 120°. The angle α may also be about 20° to about 90°, and more preferably about 20° to about 60°. In a further preferred embodiment, the angle α may be about 30° to about 60°.

The modified polymeric composite flake may have only one or a plurality of such exterior edge features formed (i.e., two or more) on the exterior surface cut to be on edge portions along the exterior edges of the modified polymeric composite flake. The flakes are cut or formed so as to have the exterior edge features on at least a portion of the exterior edge of the modified polymeric composite flake, and are cut so as to extend in the x-y plane as well as over the thickness in the z direction of the flake so that the features span the opposing exterior surface areas 118, 119 along the thickness t of the modified flake 100. It is possible to form the exterior edge features to extend through only a partial thickness of the flakes or to have them angled in a wedge-like manner over the thickness direction so as to be progressive in two planes, however, it is more preferred, and easier to manufacture to form the exterior edge features to span the thickness of the flake as shown.

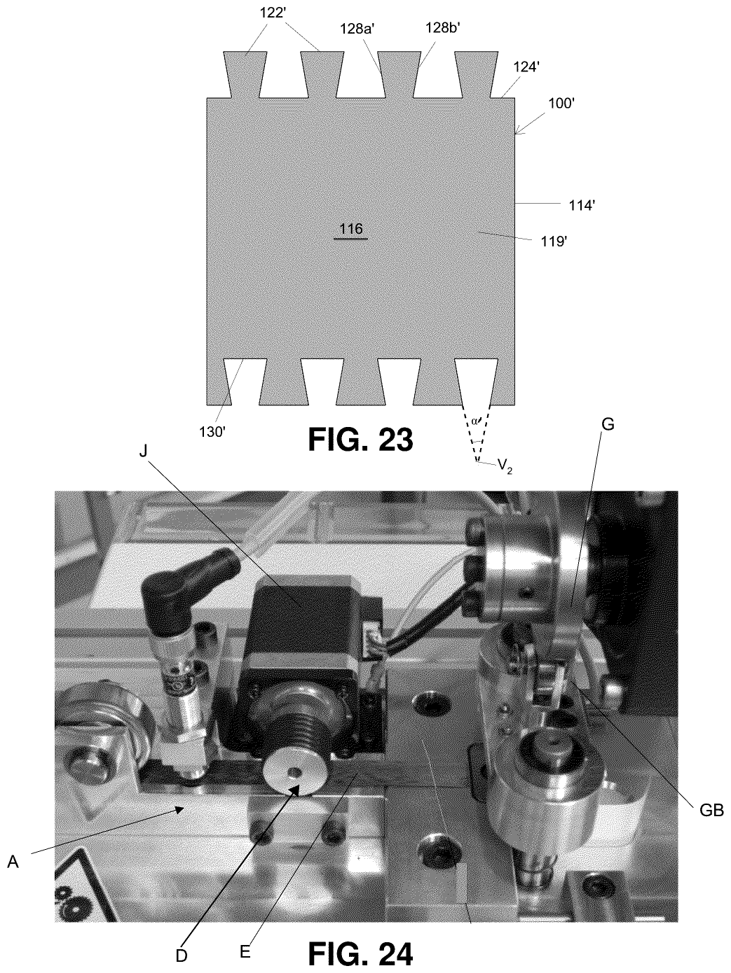

Exterior edge features may be formed that are not triangular in plan view as shown in FIGS. 3 and 4, that do not have contiguous sides and also that do not contact one another in a single point of contact when contiguous in a pattern. FIG. 23 provides one example of such an alternative embodiment of a modified polymeric composite flake 100′, with two exterior edge features 122′ having angled sides 128a′, 128b′ that form a trapezoidal shape for exterior edge features 122′ into the edge portion 124′ on edge 114′ of modified flake 100′ extending over its thickness. The angled edges of each edge feature angle towards one another but do not meet in a vertex and so are not triangular at an outer terminal end thereof. The angled sides are angled toward one another to form an angle α′ with respect to each other having a projected vertex V₂ outside the ends of the angled sides as shown in FIG. 4. The sides 128a′, 128b′ are not contiguous. In addition, the exterior edge features 122′ for a pattern. The patterned features are connected by a linear edge portion 130′ and are configured in a pattern that is like a “dovetail” design. It is also noted that in a preferred embodiment, the pattern on one edge portion is a reverse pattern on the opposing edge portion so that an outwardly extending trapezoid on a first edge portion is longitudinally aligned (preferably in a fiber direction) with an inwardly extending trapezoidal gap on the opposing edge portion. This arrangement provides the optional benefit of maintaining the fiber length as consistent from one end of the pattern of exterior edge features to the other end thereof.

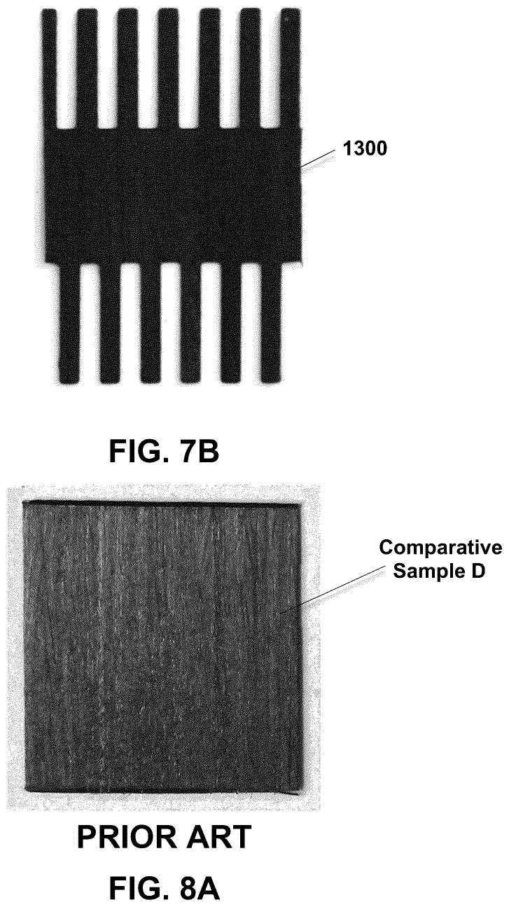

With respect to FIGS. 3 and 4 (and the flakes shown from the Examples in FIGS. 3A-3C), a plurality of the exterior edge features 122 are provided on two opposing exterior edge portions 124, 126 out of a total of four exterior edge portions 124, 126, 130, 132 on the modified flake shown, which is a modified polymeric composite flake formed having opposing parallelogram-shaped exterior surface areas, in this instance the modified polymeric composite flake was formed as a square flake having exterior edge features. Each of the exterior edge features 122 on the exterior edge of the exterior surface is made on either of the edge portions 124, 126 and is formed so as to be contiguous to one another and to contact one another in a single point of contact P₃ (unlike the features in FIGS. 7A, 7B, 16, 19 and 22-23 which connected by a linear edge portion shown as 130′ in FIG. 23).

The contiguous nature of the angled edge portions with respect to one another in FIGS. 3 and 4 provide a zig zag pattern Z to the edge portions 124, 126. Four exterior edge features are shown in FIGS. 3 and 4 (and in FIGS. 3A) on each of the side edge portions 124, 126 (modified flake 100), which was used in Examples 1, 2 and 3 herein based on the configuration of FIGS. 3 and 4, each having an angle α of about 30° between contiguous exterior edge portions. Similar designs are also shown and used in Example 2 (FIGS. 3B and 3C) which show similar modified flakes 200, 300 respectively, each having a similar configuration to that of modified flake 100 and four exterior edge features, but having angles α of 60° in FIG. 3B and 90° in FIG. 3C.

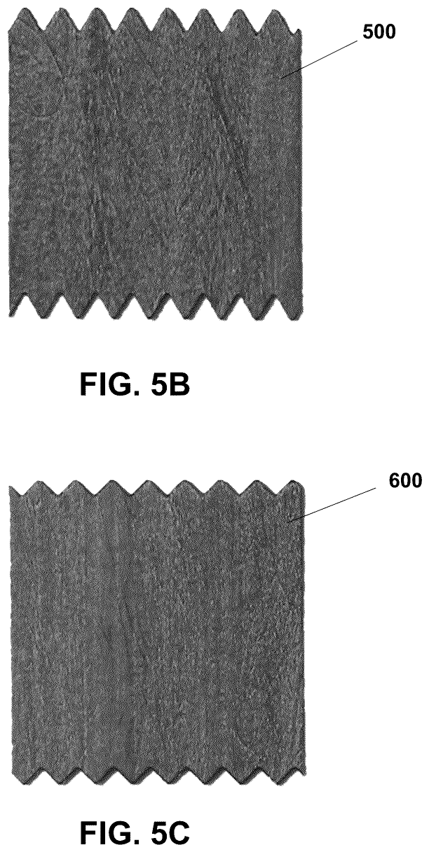

FIGS. 5A, 5B and 5C show respective modified polymeric composite flakes 400, 500, 600 respectively similar to that shown in FIGS. 3-3C and 4, and are flakes used in the Samples in Example 2, but those of FIGS. 5A-5C have eight exterior edge features and respective angles α of 30°, 60° and 90°. Each also has exterior edge features on two opposing edge portions of the four edge portions shown for modified flakes 400, 500 and 600.

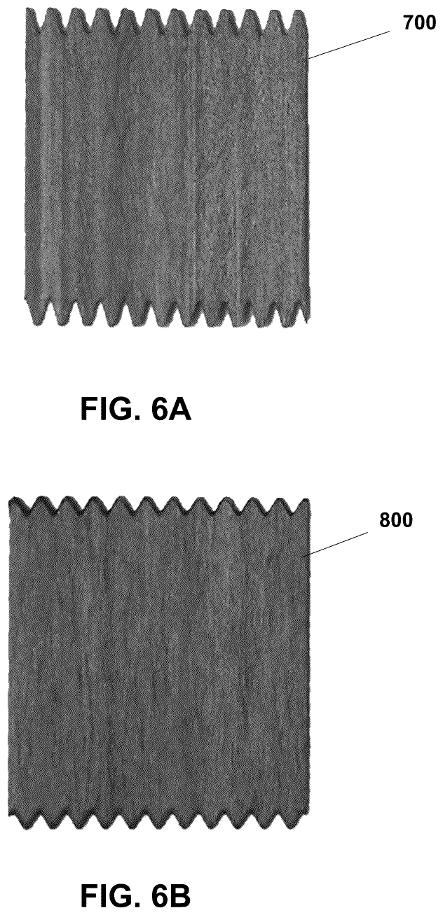

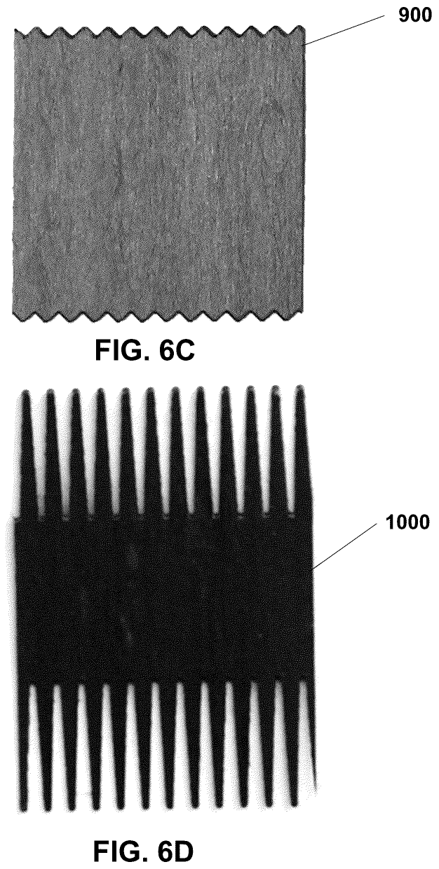

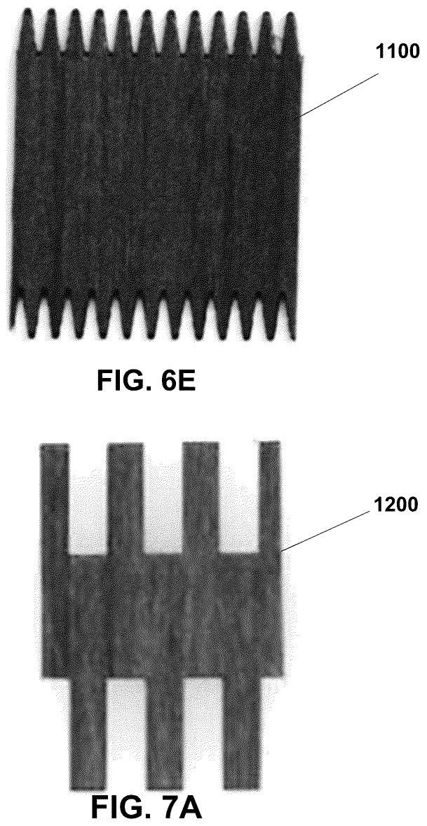

FIGS. 6A, 6B, 6C, 6D and 6E also show further modified polymeric composite flakes 700, 800, 900, 1000, and 1100 respectively, also similar to the flakes of FIGS. 3-3C and 4, but having twelve exterior edge features and respective angles α of 30°, 60°, 90°, 5° and 15°. These flakes are also used in Example 2 herein.

In some instances, the exterior edge features form a pattern, but are configured such that they do not meet at a common point of contact like angled exterior edge features, such as those referenced above, typically do. When the exterior edge features are of non-fully angular shapes, parallelograms, or other shapes wherein angle α measurable in a projected manner or is 0°, patterns may be formed wherein contiguous exterior edge features in the patterns are joined by substantially linear edge portions. This is shown, for example in the stepped exterior edge feature configuration of FIGS. 7A and 7B (modified flakes 1200, 1300) and in the configurations shown in FIGS. 16, 19 and 21-23.

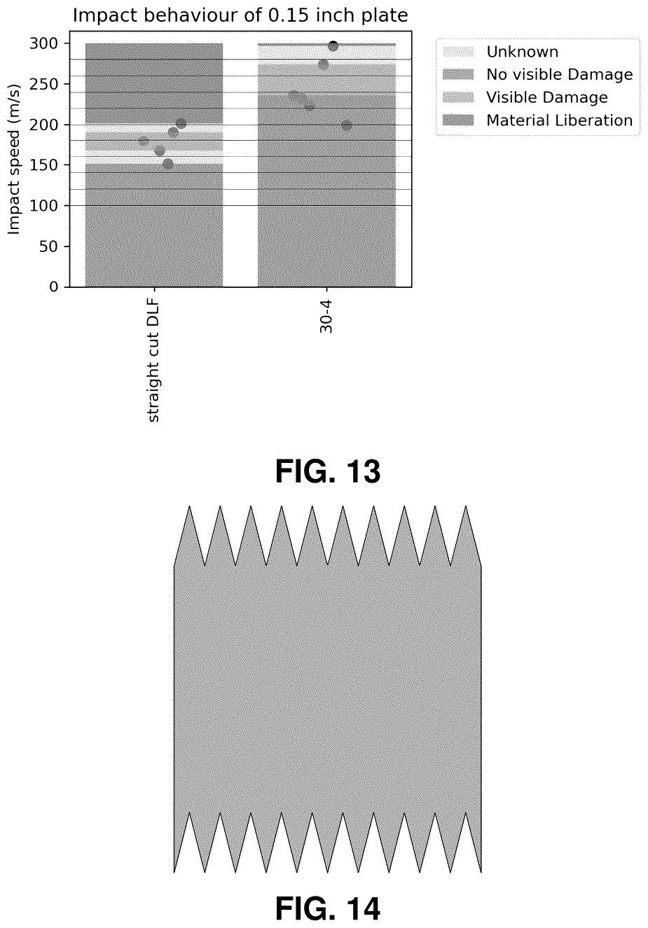

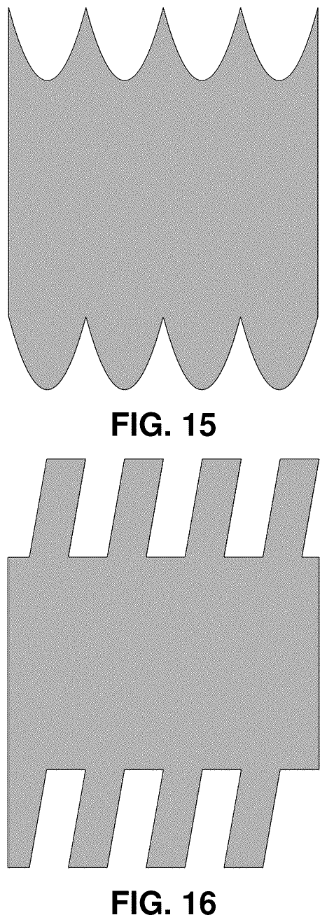

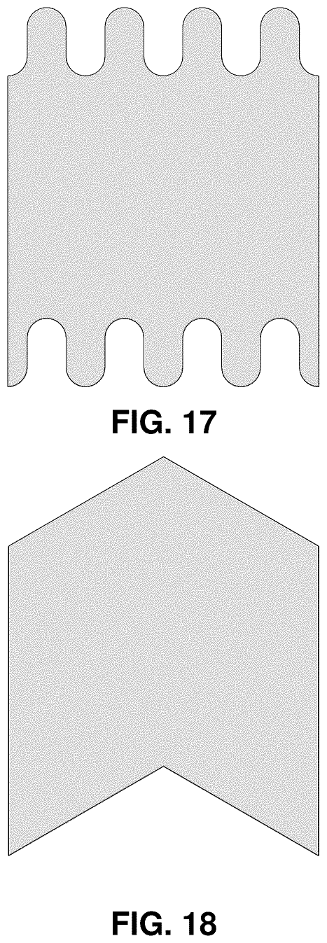

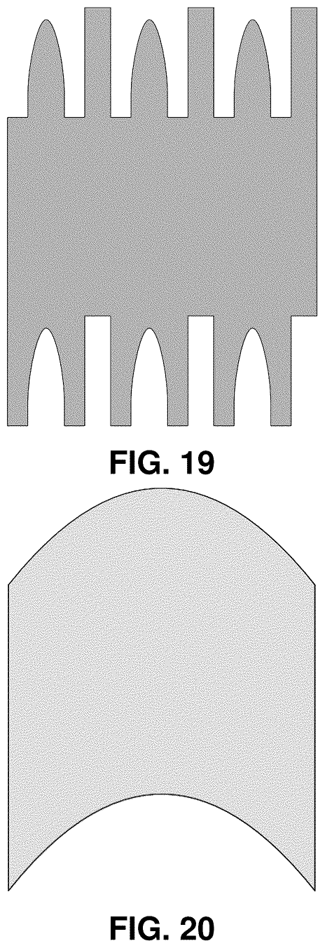

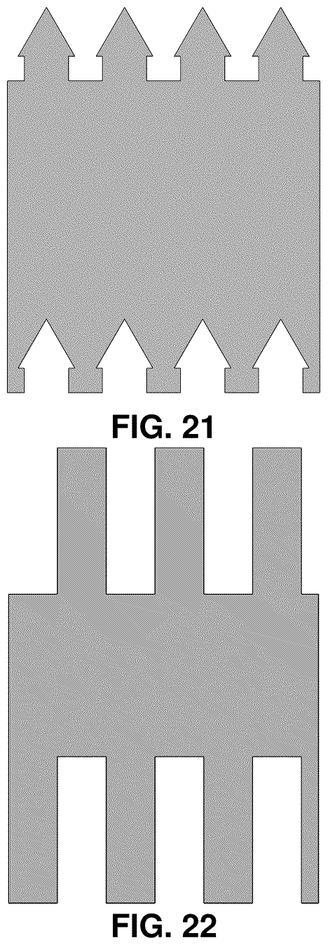

In addition to the stepped or “slotted” exterior edge configuration of FIGS. 7A, 7B and 22, further examples of patterns and uniquely shaped exterior edge features are now depicted and their shapes explained herein. FIG. 14 shows further triangular edge features wherein 10 contiguous triangular features are provided on two opposing edges of the flake shown. Parabolic patterns with four parabolic exterior edge features on opposing edges are illustrated in FIG. 15. FIG. 16 shows a configuration where exterior edge features are angled parallelograms in a variant of the rectangular slotted configuration of FIGS. 7A, 7B and 22. FIG. 17 shows a pattern of curved exterior edge features. Unlike the parabolic features of FIG. 15 wherein the sides of the features are fully curved and meet in a curved terminal end, the exterior edge features of FIG. 17 are straight and linear on their sides, but the terminal end of each feature meets in a semicircular shape so that each feature appears in the shape of the end of a tongue depressor. FIGS. 18 and 20 are examples of flakes having only one exterior edge feature on an exterior edge portion. Such feature is positioned on each of two opposing edge portions. In FIG. 18, the edge feature is triangular, whereas in FIG. 20, the edge feature is a single, fully curved feature. In FIG. 19, there is an example of use of two different exterior edge feature shapes alternating in a pattern, wherein one edge feature shape is a rectangle and the other alternating exterior edge feature is a bullet shaped feature having subtly curved sides meeting in a narrowly curved terminal end. Each of the features is connected in the pattern by a linear edge portion. FIG. 21 provides a complex edge feature having an arrowhead configuration. The arrowhead includes a rectangular base and a triangular arrowhead terminal end wherein angled sides of the triangle provide a vertex end. FIG. 22 is an example of a slotted configuration as in FIGS. 7A and 7B, but providing only three slotted features on each of two opposing edge features in FIG. 22. FIG. 23 provides an example of a trapezoidal edge feature as described further elsewhere herein.

Notably in each of the configurations, as preferred examples, patterns are provided to opposing edge portions so that “reverse” patterns appear wherein an outwardly extending edge feature on one exterior edge portion is longitudinally aligned (preferably in the fiber direction) with a corresponding inwardly extending recess into the flake on the opposite edge surface so that the fibers within the flake are of a constant length across the flake in the direction of the fibers regardless of the length of the exterior edge features themselves.

It is possible, also to form varying modified polymeric composite flake surface area shapes, as noted above, such as a circular flake as shown in FIG. 2 with all or a portion of its edge 14′ provided with such exterior edge features as described above, and similarly an elliptical or oval shaped flake may be formed as a modified polymeric composite flake in the same manner. A triangular flake or other parallelogram shape or a trapezoidal shape, i.e., a flake having 3 or more edge portions, and a polygonal flake of five or more edge portions may be made wherein at least two or more of the edge portions of each of these types of modified flakes are provided with exterior edge features.

As shown in the varying exterior edge configurations of FIGS. 3-3C, and 4 and in FIGS. 5A-5C, 6A-6E, 7A-7B and 14-23, it is possible, as best shown in FIG. 3A, that long reinforcing fibers in the flake(s) F may be unidirectional and extend through the at least one flake in a first direction D₁ and the exterior edge portion(s) selected for having the exterior edge features, including those forming zig zag and other patterns, can extend along one or more exterior edge portions in a second direction D₂ and at an angle β with respect to the direction D₁.

As shown in FIG. 3A, for example, the reinforcing long fibers F extending in a direction D₁ that is in the same as the length dimension along axis x-x′ of the flake 100. The two opposing edge portions 124, 126 shown, having exterior edge features 122, each extend along the edge portions for substantially their complete length and so as to be parallel to the width direction D₂ along axis y-y′ of the flake 100 at an angle β that, as shown, is generally orthogonal to the direction D₁ and which are formed so that the exterior edge features extend outwardly from the main body surface area of the modified flake defined by the edges preferably A in the direction D₁. Angle β may be varied, however, for differing flake designs, such as those having angled sides (e.g., triangular flake, polygonal or trapezoidal flakes) or may simply involve a further additional edge features made to the flake when cutting, stamping, chopping or otherwise forming the modified polymeric composite flake, by providing, e.g. a modified flake that is overall parallelogram-shaped having four sides, ant cutting at least one side cut formed at an angle to the angle of the direction D₁ in which the fiber(s) are extending.

While using an angle β is optional, i.e., the exterior edge feature(s) and/or a zig zag pattern thereof, are preferably provided on an exterior edge portion of a modified flake running parallel to a fiber direction D₁ of a flake having unidirectional fiber, or the modified flake may not have unidirectional fiber (such as a woven structure or more random or angled fibers). When providing unidirectional fibers, it is preferred that the portions of the exterior edges having the exterior edge feature(s) and/or a zig zag or other pattern be at an angle with respect to the fiber direction D₁.

While the fiber(s) are not shown in FIGS. 1-4 and FIGS. 14-23, when viewing the modified flakes as depicted, it should be understood to one skilled in the art that the drawings of modified polymeric composite flakes shown are for configuration illustration purpose and to highlight dimensional terms to thereby show the shape and configuration of the flakes 100 both before modification (see FIGS. 1, 1A and 2) and after modification (see FIGS. 3, 4 and 14-23). Unmodified flakes are known in the art and those skilled in the art would appreciate, based on this disclosure, that the fibers would be embedded and impregnated within the composite from which the modified flakes are formed and within the modified flakes after cutting them from the composite. They may extend in one or more directions, and are preferably unidirectional as noted elsewhere herein.

The exterior edge features of the modified polymeric composite flakes herein provide to articles formed therefrom enhanced tensile strength and/or increased impact resistance particularly at high velocities and/or a higher failure limit due to the reduction in stress concentration at the edge of the flakes by forming edge portion(s) having exterior edge feature(s) alone, in groups and/or in zig zag and other patterns.

Applicant has used the Inglis equation to help evaluate the stress at the edge of a composite tape by analogy. In the Inglis equation, stress may be approximated as the stress at the edge of a hole within a composite, wherein the hole has an elliptical shape and wherein the width of the hole approximates the thickness of a unidirectionally aligned fiber-reinforced composite. The Inglis equation expresses the relationship of stress for such a hole as in equation (I) below, where the parameters of the hole, a and b, approximate a hole's width and length, respectively and σₘₐₓ/σ is the stress concentration factor and the maximum strength (stress) applies at the edge of the hole σₘₐₓ while the composite is under an axial stress, σ in the direction of b.

$${σ}_{max} = σ ( 1 + 2 \frac{a}{b} ) \qquad ( I )$$

This use of the Inglis equation for stress at the edge of a hole has been applied by applicant by analogy to approximate the relationship between composite thickness and tensile strength.

The analogy compares the stress observed next to a hole that exists in a plate when the plate is put under tension. If the hole is circular, stress concentration reaches three times the applied stress to the plate. When considering a discontinuous long fiber plate under tension, with reference to a standard flake having no modified edge features, the mechanical properties (strength and stiffness) drop to practically zero at the edge of the flake in the fiber direction.

For example, in a 140 micron thick flake, the edge of the flake represents a “stack” of over 20 fibers in thickness (assuming a diameter of about 7 microns) and all stop abruptly as they are all cut to the same length in a blunt edge. The surrounding flakes when forming molded articles can bridge the flake edge, but over a distance of about 1 flake thickness there will be no fibers and only polymer. The strength and stiffness of the composite flake in the fiber direction is about 2130 MPa and 135 GPa, respectively, that are used in a commercial carbon/PEEK flake. The strength and stiffness of PEEK (the polymer surrounding the edge of the flake) used in such flakes is about 100 MPa and 3.7 GPa, respectively. With over 20 times less strength and stiffness, they can be approximated at zero properties. That is, even without an actual “hole” at the end of a standard commercial carbon fiber/PEEK flake, as it becomes a resin rich area, from a strength and stiffness perspective, it is in some sense analogous to a hole.

Attempts to make flakes thinner, using an analogy to the Inglis equation, can view the analogous hole as elliptical, so that the thickness (a axis of the hole) is reduced and thereby the stress concentration factor should be reduced. However, in the present invention, providing modified edge features, for example to provide a pattern such as a zig zag, creates essentially a progressive edge or a softer transition from locations high carbon fiber properties within the flake to outwardly extending terminal ends of the exterior edge features (such as the point of a triangle feature) where the properties are again close to zero. By analogy to the Inglis equation again, this is as if the axis b of the ellipse increases so that stress concentration factor is reduced. Thus, instead of making the flake thinner to increase strength, the thickness is retained, and the fiber length and amount are retained, but the edges become progressive while the stress concentration factor is still reduced. This makes the transition between zero properties at the very outer edge and the high level of strength properties within the flake less dramatic and more gradual in transition. Changing a in the equation can be more effective in some instances, but is not cost effective from a manufacturing perspective.

Applicant already attempted to use various discontinuous long reinforcing flake of varying lengths in applicant's U.S. Pat. No. 10,160,146. However, while providing well molded products and good isotropy, strength is not sufficiently improved in the final molded articles formed of such composite tape. Based on applicant's data, applicant's theory that the “length” parameter b when provided to each modified flake was important in the ultimate increase in the strength of articles formed from the modified flakes as well as to enhanced isotropy in strength. Not only was strength significantly improved, but also the impact resistance, particularly at high velocity and the fatigue limit were increased as well.

### EXAMPLES

In further exploring the impacts of the invention herein, it was further found that the number of exterior edge features as well as the angles or nature of the sides of the exterior edge features may be modified or varied to achieve in the resulting articles formed from the modified polymeric composite flakes the best impact to the degree to which strength and/or failure limit and/or high velocity impact resistance is/are improved by varying the features. This is borne out in the following Examples. Each of the Examples herein are intended to help illustrate the invention, but should not be considered to be limiting.

### Example 1

Unidirectional composite tapes having continuous long reinforcing fibers extending in the lengthwise direction were used in the following Examples. Specifically, three commercially available polyetheretherketone composite tapes were tested from Solvay, Barrday and Tencate (Toray). Samples were made having AS4 carbon fibers (C/PEEK) (Samples A, B and C) that were cut into straight, square-shaped flakes of 0.5 in.×0.5 in. dimensions on the exterior surface area as defined by the flake edges so as to appear in the manner of the prior art flake in FIG. 1. Modified polymeric composite flakes were formed of the same materials as shown in FIG. 3B having a zig zag pattern and an outer configuration as illustrated in FIGS. 3 and 4 on two opposing edges thereof. On a first one of the two opposing edges, the zig zag pattern included four outwardly extending exterior edge features having angled sides, which angled sides formed a vertex (thus appearing in triangular shape), and an angle α of 30° was provided between contiguous pairs of the exterior edge features. On the other second opposing edge, the zig zag pattern was situated so that where an angled edge feature extended outwardly on the second opposing side, its vertex was axially aligned with the contiguous mating point between two continuous edge features on the first side. Thus, the second edge included three edge features of identical triangular shape to the features formed on first edge, with 30° angles between continuous features (angle α), but on terminal ends of the second edge, are two narrower partial edge features, each spaced 30° from the contiguous three features. The partial features together form about one half of a complete edge feature as in the rest of the pattern, thereby providing the benefit of a total of four exterior edge features, each having two sides with angles therebetween. The exterior edge features formed patterns on each of the opposing edges which extend over the length of the edges in the 0.5 in. dimension of the flake. The carbon fibers extended in a direction that is generally orthogonal to the two opposing edges having exterior edge features (angle β is 90°). The length between each of the opposing sides measured directly across the flake from one opposing side to the other, due to the pattern formed on the opposing sides, were approximately the same length along the edges of the two opposing exterior edges having the exterior edge features, thus maintaining continuous fiber length, but providing progressive (transitional) exposure of fiber ends due to the cutting of the pattern into the flakes.

The composite tapes used each had a nominal thickness of 0.14 mm and incorporated approximately the same purported fiber volume of 61%. The flake material in the modified polymeric composite flakes was molded into 0.1 in. thick plates having a dimension of 12 in.×12 in. using a compression molding process and cut into “dog bone”-shaped samples of a 1 in. width in the gauge area. A minimum of 20 samples were tested for each configuration using the tensile testing method of American Standard Testing Method (ASTM) standard number ASTM D3039-17.

The molding process included forming the flakes by cutting with a device capable of chopping a unidirectional tape into repeatable flake geometries. The required quantity of flakes was weighed and filled by hand (but could have been filled by a robotic system) so as to evenly spread the flakes into a square mold cavity having dimensions of 12 in.×12 in. The mold was heated in a hot press to about 400° C., although processing temperatures of between about 360° C. and about 430° C. may be used. The material was subjected to applied pressure of about 100 bar. Process pressures of about 60 bar to about 150 bar on the material may be used. The material was then cooled down in a cold press under the same applied pressure. The plates made were about 0.1 in. in thickness, and each was machined into seven (7) dog bone-shaped samples of 1 in. width.

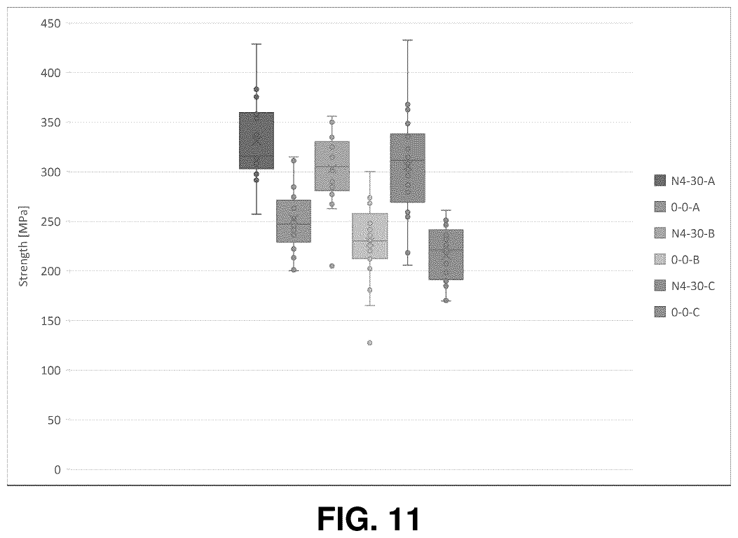

FIG. 11 shows that there was an increase in tensile strength of the articles formed from the flakes when the flakes were modified independent of the supplier of the raw materials. The materials from all three sources showed a similar increase of from about 30% to about 40% when modified over a flake formed of the same composite material in the configuration of a square flake like FIG. 1 without modification. In the graph, the samples are identified in an unmodified state as “0-0-A”, “0-0-B” and “0-0-C” for each commercial Sample from which moldings were made from unmodified flakes having no exterior edge features provided. Such commercial samples were square in shape having a configuration like that of FIGS. 1 and 1A. The modified Samples bear the commercial Sample identifier (A, B, or C) but note the total number (N) of exterior edge features used on the modified flakes on the two opposing edge portions and the angle between the exterior edge features provided, e.g., Sample A had four exterior edge features positioned on each of two opposing exterior edge portions, which portions extended the length of the exterior edge of a square surface area defined by the exterior edge and the exterior edge features were triangular and contiguous with an angle between each feature of 30°. They were thus designated as N4-30-A. The unmodified version of Sample A was designated by 0-0-A.

### Example 2

In this Example, two commercial composite (C/PEEK) unidirectional tapes were used having AS4 carbon fiber to create a variety of inventive Samples. The tapes were from Solvay and Tencate (Toray). The number, shape and angles of the exterior edge features on the inventive Samples of modified polymeric composite flakes were varied. Flakes were formed for molding by chopping the unidirectional composite tape so that the modified flakes formed were 0.5 in.×0.5 in. modified flakes having long fibers from the tape therein.

In addition to the inventive Samples, comparative prior art samples were used. Comparative Sample D had a square surface area defined by its exterior edges of 0.5 in.×0.5 in. using a design as shown in FIG. 1 and was an unmodified flake. A further Comparative Sample E was provided that was a bias-cut flake that had linear edges and was cut so as to have biased edges cut at a 45° angle.

Thirteen different inventive Samples were made each with a varied exterior edge feature and/or varied number of features. All of the inventive Samples were oriented similarly in that exterior edge features were positioned on two opposing exterior edge portions, the modified flakes are of an overall parallelogram type having edge features formed therein as noted above, and the exterior edge portions having the exterior edge features were positioned to extend at an angle β of 90° to the direction of fiber extension in the modified flakes.

Some of the inventive Samples in this Example were formed similarly to the modified polymeric composite flakes in the Inventive Samples of Example 1 herein, i.e., they had “triangular” exterior edge features that formed a zig zag pattern, included on opposing exterior edge portions with an angle α between the contiguous exterior edge features. In the design, the “teeth” were staggered on opposing edges so that the vertex of an exterior edge feature on a first opposing side aligned along the fiber direction across the flake with the point of contact between two continuous exterior edge features on a second opposing edge of the modified flake so that the fiber length was generally consistent along the modified flake.

These Samples were named by reference to the angle α between the contiguous exterior edge features and by the number of outwardly extending exterior edge features (in this case, “teeth”). For Example, in the first inventive sample, Sample 30-4, “30” represents the angle α between the exterior edge features and “4” represents the number of exterior edge features on each opposing exterior edge portion. The angles and number of exterior edge features were then varied and named accordingly in other inventive Samples having triangular edge features.

Inventive Samples were also formed using rectangularly shaped exterior edge features in a “step-cut” variation. As the features were rectangular, their sides are joined by a straight portion and there is no “vertex” formed on the exterior edge features such that the angle α between them is 0°. Each feature was not connected to the next exterior edge feature by a single point as with triangular exterior edge features, but was instead connected by a substantially straight edge portion having a width that was the same as the width of the step exterior edge feature. Each such modified flake had a series of rectangular “teeth” and were cut so as to appear elongated. Fibers extended also in the direction of the features so as to have an angle β of 90° and to be orthogonal to the direction of extension of the opposing exterior edge portions including the exterior end features. The patterns had similarly aligned features on each of the opposing edge features staggered so that the outwardly extending rectangular edge feature on a first exterior edge portion aligned with the space between two outwardly extending exterior edge portions on the second opposing edge portion. These Samples were identified, e.g., as Sample 6×2, where “6” is the depth in mm of the cut and “2” is the width in mm of the rectangular exterior edge feature in mm.

The same modified flakes for each configuration were made using both commercially available tape materials and the data for each type of material was averaged to provide the data herein.

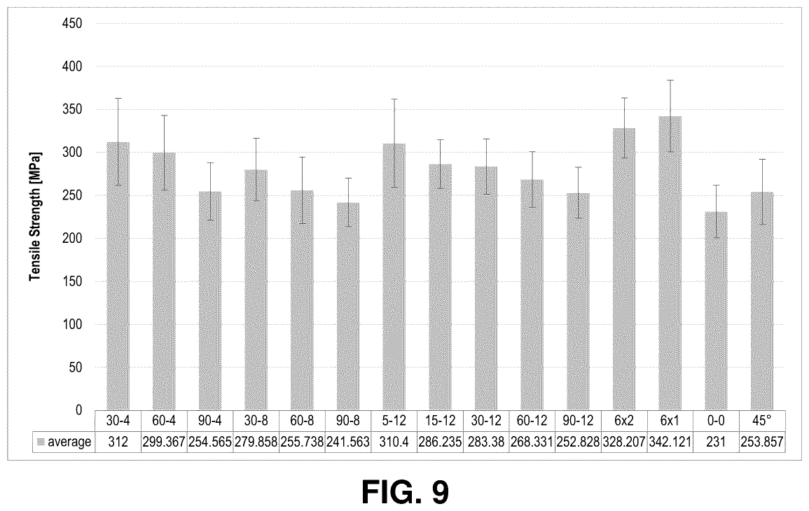

FIGS. 3B-3D, 5A-5C, 6A-6E and 7A-7B represent the inventive Samples of modified flake shown in the Table of FIG. 9 respectively identified as Samples 30-4, 60-4, 90-4, 30-8, 60-8, 90-8, 30-12, 60-12, 90-12, 5-12, 15-12, 6×2, and 6×1. Such Samples are represented also, in respective order in FIGS. 3A-3C (flakes 100, 200 and 300), FIGS. 5A-5C (flakes 400, 500 and 600), FIGS. 6A-6E (flakes 700, 800, 900, 1000 and 1100) and in FIGS. 7A-7B (flakes 1100 and 1200).

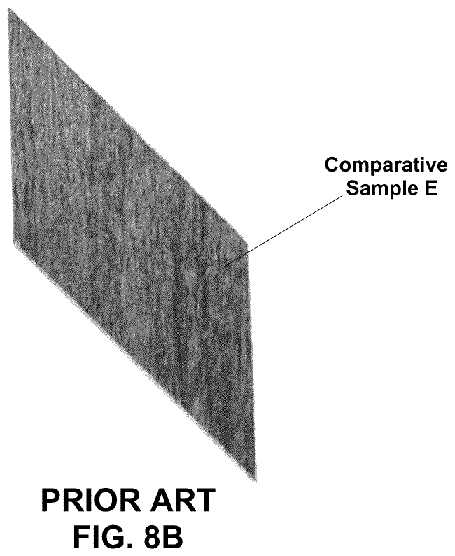

FIGS. 8A and 8B depict the Comparative Samples D (square cut unmodified by edge features) and E (biased cut unmodified by edge features).

Each of the inventive and comparative Samples was tested using ASTM D3039-17. FIG. 9 shows the average tensile strength for articles formed from all modified flake geometries. All inventive Samples having modifications to provide exterior edge features in testing showed an increase in tensile strength after providing the modified edge features.

The Comparative Sample E (biased cut) showed a marginal strength increase compared to the Comparative Sample D. While it is known that using longer fibers (and thus longer flakes in the fiber direction) can have a similar strengthening effect, the longer fibers often have been observed as providing more difficulties in processing.

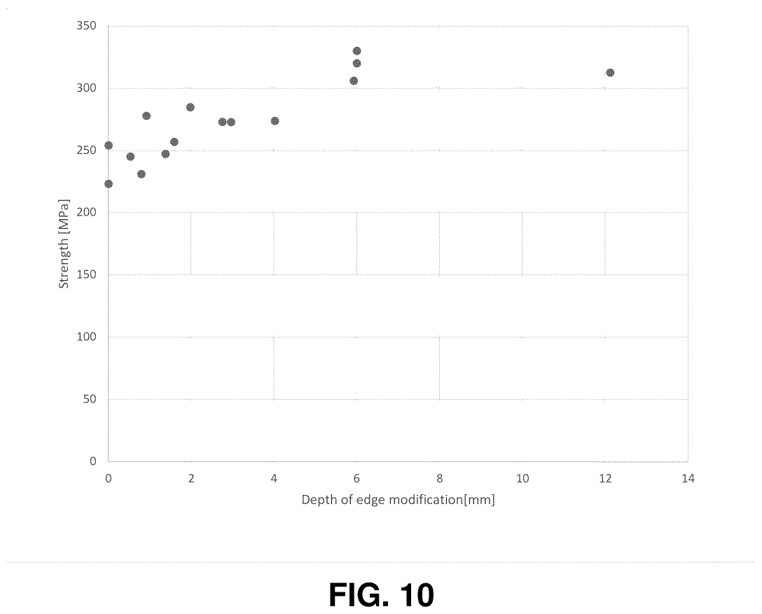

In contrast, the inventive Samples and modified polymeric composite flakes used herein having a modified edge from exterior edge features maintained the same fiber length of an original flake and retained the ease of processing of square flakes while benefiting from the enhanced strength. FIG. 10 further illustrates that the deeper the edge modification reached into the inventive Samples tested, the bigger the increase in tensile strength. The articles formed illustrate that the average tensile strength of flakes formed in the inventive Samples was higher than expected from unmodified flake, and variations of the flake designs in the Inventive Samples show that improvement and strength properties can be modified depending on the configuration or number of the exterior edge features and/or adjustment of the angle or spacing between the exterior edge features. Thus, more or less exterior edge features, variations in shape or angle, and depth of the cut of modified edge features into the flake can be employed and varied to form articles from the modified flakes and using the method herein that each show good results, but can be adjusted to achieve an optimal improvement or strength level for a given polymeric matrix material and intended end application.

### Example 3

The impact of hail is a particular concern in the aerospace industry as hail can impact any exposed part of an aircraft at its travel speed of up to 250 m/s. A material's ability to resist impact of projectiles, particularly at a high velocity, is important to providing suitable composites that can be employed in aircraft manufacture. Impact resistance also is important in areas that are subjected to large hail or large hail from strong storms with high velocity wind that can cause significant property damage or injury.

Impact resistance, particularly at a high velocity, can be assessed by studying the impact of artificial hail stones on coupons and real parts. To do so, and evaluate the behavior of materials formed from modified polymeric composite flakes according to the present invention, modified flakes were formed using Inventive Sample 30-4 of Example 2, i.e., flakes of 0.5 in.×0.5 in. dimensions were formed with a square configuration from 0.5 in. wide composite tape, and such flakes included as cut a total of four exterior edge features (aligned to offset an outwardly extending exterior edge features on a first exterior edge portion with a common point between two contiguous exterior edge features on an opposing exterior edge portion) with the contiguous exterior edge features being triangularly shaped and having an angle of 30° therebetween. Comparative flakes with unmodified edges (having no edge features) like those of Comparative Sample D of Example 2 were also used in this Example.

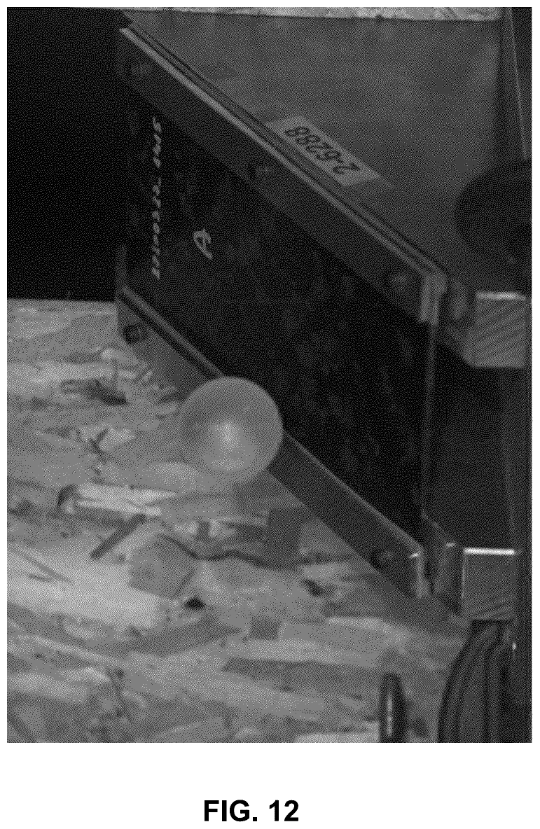

The modified polymeric composite flakes were molded using the molding process noted above to form plates of a size that was 12 in.×12 in. and having a thickness of 0.15 in. Each of the plates was cut in half to form two 12 in.×6 in. plates. The plates were then put into a testing jig shown in FIG. 12. The plates were clamped along a 1 in. distance on both of each plate's longer side edges with rubber bolstered clamps leaving the plate free for the 4 in. width between the clamps. The plates were each inclined by 30° from a horizontally extending plane. The inclined plates were then impacted with hail stones of a diameter of 50 mm at a temperature of −18° C. shot at speeds between 100 and 300 m/s with a horizontal trajectory onto the center of the plate.

After impact, the plates were inspected, and the damage was rated at either: (i) no visible damage; (ii) visible damage and/or (iii) material liberation. FIG. 13 shows a graphical illustration of the data where each test was marked as a dot on the chart shown. The results indicated that the modified polymeric composite flakes provided a significant improvement over straight cut flakes. The speed at which damage occurs increased by about 75 m/s and material liberation did not occur until about a 100 m/s higher speed when comparing the plates formed from the modified flake Sample to the plates formed from the unmodified flake Comparative Samples.

### Example 4

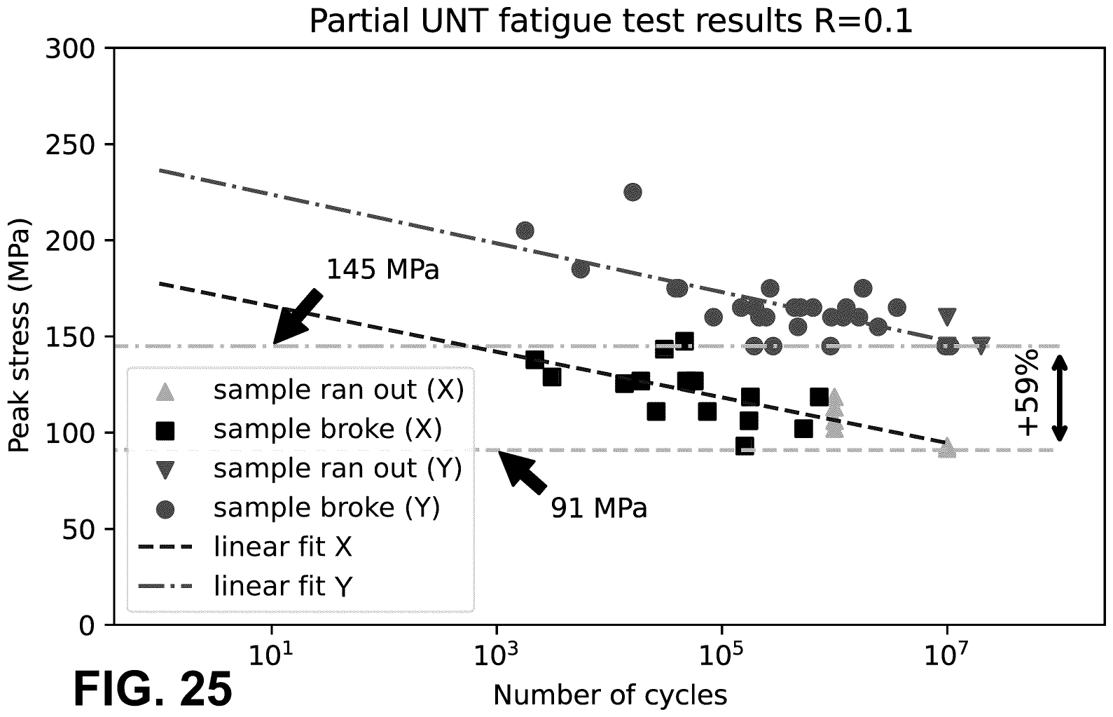

To further evaluate the invention with respect to fatigue resistance, unnotched tension samples were manufactured and were cycled in in fatigue with a stress ratio of R=0.1. FIG. 25 shows the results of this testing, where the applied stress level in MPa is plotted against the number of cycles applied before specimen failure. Some samples ran-out without failure and are shown with a different marker.

In this Example, unmodified flakes of a square shape (0.5 in. sides) without edge features were used to manufacture a specimen for testing (Comparative Example X) and flakes as formed in Example 1 were used to manufacture an inventive specimen for testing (Iventive Sample Y). Both types of flakes were cut out from the same carbon and PEEK (C/PEEK) unidirectional tape. The modified flakes used to form Inventive Sample Y were modified to have four “triangular” exterior edge features (“teeth”) that formed a zig zag pattern with a 30° angle α between each feature and a square geometry (0.5 in. dimension) as in Example 1. The features were on two opposing exterior edge portions with the angle a between the contiguous exterior edge features. The fibers were oriented to run between the edges having the edge features and orthogonal to the direction of extension of the edges having the edge features (i.e., a 90° angle β as described above herein). In the design, the teeth were staggered on opposing edges so that the vertex of an exterior edge feature on a first opposing side aligned along the fiber direction across the flake with the point of contact between two continuous exterior edge features on a second opposing edge of the modified flake so that the fiber length was generally consistent along the modified flake.

The fatigue life of Comparative Sample X and Inventive Sample Y were evaluated using unnotched tension specimens formed from the unmodified (Comparative Sample X) and modified (Inventive Sample Y) flakes. The data on FIG. 25 shows where the various unnoted tension specimens broke or ran out. A linear fit for each set of data points is shown in FIG. 25 for both of the Samples X and Y. Based on the linear fit, a significant increase of about 59% in high cycle fatigue life is shown when using the same composite but with modified flake instead of a standard flake.

### Example 5

In this Example, unmodified and modified flakes formed according to Example 4 were used to prepare samples for testing for high velocity hail impact (i.e., Comparative Sample X and Inventive Sample Y). The Comparative Sample X composite samples were formed using the unmodified flake, and the Inventive Sample Y composite samples were formed using the modified flake, each using the square geometry with 0.5 in. dimension. A further inventive composite (Inventive Sample Z) was prepared using modified flake manufactured from the identical composite as Inventive Sample Y but having a rectangular shape with a length (dimension along the fiber direction) of 1.0 in. The orthogonal width direction had the same width dimension (0.5 in.) as Inventive Sample Y. The edge features where of the same character as Inventive Sample Y, and were located along the edges extending in the width dimension.

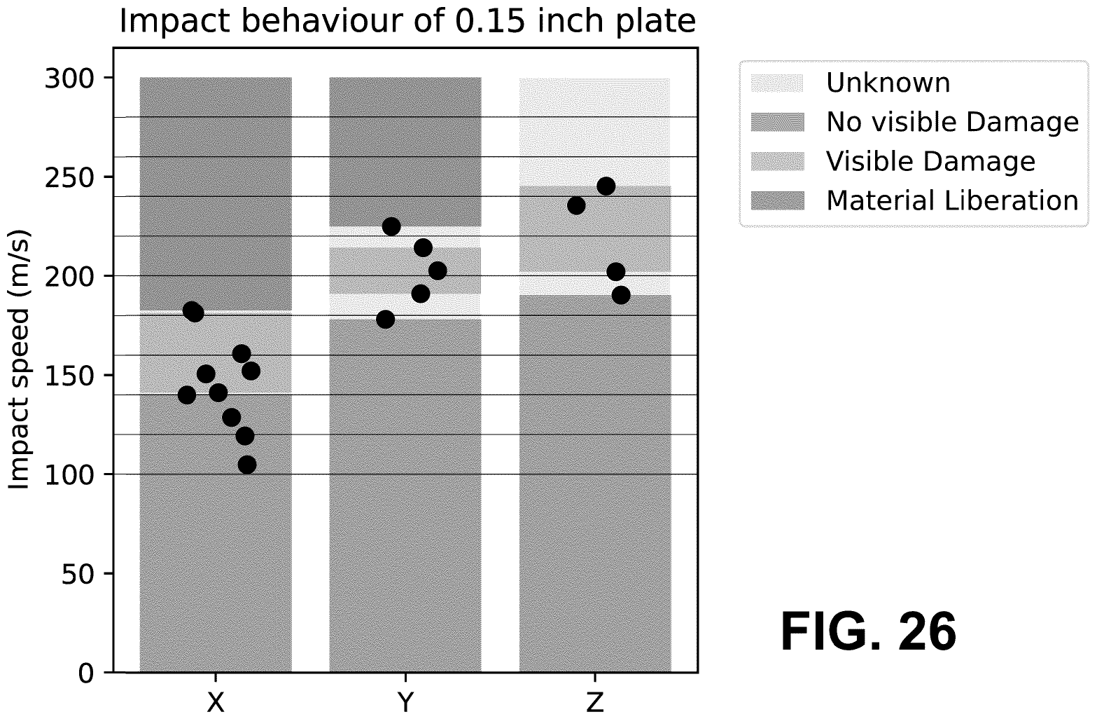

The apparatus and method of Example 3 (including the parameters noted in Example 3) were used to test samples of Comparative Sample X, and Inventive Samples Y and Z. The impact behavior is shown in FIG. 26 in which plates were inspected, and damage was rated at either: (i) no visible damage; (ii) visible damage and/or (iii) material liberation. Similar to the results shown in FIG. 13 of Example 3, the results shown demonstrate that the modified composite flakes of Inventive Sample Y provided a significant improvement over the unmodified (straight cut) flakes of Comparative Sample X. The speed at which damage occurred in Inventive Sample Y increased significantly over Comparative Sample X and material liberation did not occur until about 225 m/s. Inventive Sample Z performed slightly better than Inventive Sample Y in terms of the onset of visible damage and without apparent material liberation in the tested samples. Inventive Sample Z was also significantly better in high velocity impact resistance in comparison to Comparative Sample X. The results demonstrated that the longer flakes provide a further improvement, and the beneficial properties obtained by the progressive ends in edge features of the modified flakes is cumulative of gains that can be obtained by employing longer fibers.

As the above disclosure and Examples show, articles formed from modified polymeric composite flakes and/or using the methods herein may be of a variety of types and can vary depending on the composite chosen, such that, for example, a plurality of modified polymeric composite flakes as described herein may be used to form articles that are an apparatus, a component or a part, and that may be used in various end applications. For example, the articles may be formed as aircraft components that are strong and of light weight, medical devices, containment shells and/or components for use in high temperature and high pressure end applications (as in semiconductor, fluid handling or downhole oilfield conditions). Aircraft parts may be formed such as brackets, covers, or fairings or cabin sidewall attachments may be formed. Other end applications include apparatus, components or parts used in the robotics, automotive, semiconductor or sports industries, for example, legs for robots, encasing of dampers in automobiles, wafer handling tools for semiconductor processing and parts for bicycles.

Such articles may be formed by heat molding or curing, depending on the type of matrix polymer, a plurality of modified polymeric composite flakes provided according to the methods herein and formed into an article directly or mixing the modified polymeric composite flakes with other types of flake for different effects. When a second or additional type(s) of flakes is used, such flakes may be modified flakes according to the methods herein or unmodified flakes. In addition when using a second or additional type(s) of flake with the modified flakes herein, the polymeric matrix material and/or reinforcing fiber may be the same or different than that of the modified flakes with which they are combined. Preferred molding conditions are described above.

As the Examples support, the invention herein also provides a method of increasing one or more of an average tensile strength and/or impact resistance, particularly high-velocity impact resistance for articles formed using the modified polymeric composite flakes having the exterior edge features in comparison to articles formed from standard unmodified composite flake formed so as to have a polymeric matrix material and reinforcing long fiber(s) therein extending through the flake. The improvement is derived from providing one or more of the exterior edge features as described hereinabove to portions of the exterior edges of modified polymeric composite flakes provided herein using techniques as described above. Fatigue limit for such articles may also be increased using the modified flakes and methods herein.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A method of providing a modified polymeric composite flake for use in forming articles, comprising:
(a) providing a composite having at least one polymeric matrix material and long reinforcing fibers of a first fiber material extending through the polymeric matrix material; and
(b) forming from the composite at least one flake, wherein the at least one flake comprises an exterior surface having an exterior edge, a portion of the exterior edge being configured to provide at least one exterior edge feature to the exterior edge of the at least one flake thereby providing a modified polymeric composite flake.

2. The method according to claim 1, further comprising forming the at least one flake by cutting the composite to form the at least one flake.

3. The method according to claim 2, wherein the at least one flake is cut by a cutting device.

4. The method according to claim 1, wherein the composite is in a form selected from a tape, a plate, and a sheet.

5. The method according to claim 1, wherein the long reinforcing fibers within the composite are unidirectional.

6. The method according to claim 5, wherein the long reinforcing fibers within the composite are continuous long reinforcing fibers.

7. The method according to claim 1, wherein the composite is in the form of a tape and the long reinforcing fibers are unidirectional continuous long reinforcing fibers.

8. The method according to claim 1, wherein the at least one exterior edge feature has at least two angled sides.

9. The method according to claim 8, wherein the at least two angled sides of the exterior edge feature are angled towards each other at an angle of about 5° to about 120°.

10. The method according to claim 9, wherein the at least two angled sides of the exterior edge feature are angled towards each other at an angle of about 20° to about 90°.

11. The method according to claim 10, wherein the at least two angled sides of the exterior edge feature are angled towards each other at an angle of about 20° to about 60°.

12. The method according to claim 11, wherein the at least two angled sides of the exterior edge feature are angled towards each other an angle of about 30° to about 60°.

13. The method according to claim 12, wherein the at least two angled sides of the exterior edge feat(original) ure are contiguous and together form a vertex of the angle at a point of contact between the at least two angled sides.

14. The method according to claim 8, wherein there are a plurality of exterior edge features.

15. The method according to claim 14, wherein the at least two angled sides of each exterior edge fe(original) ature are contiguous and together form a vertex of an angle at a point of contact between the at least two angled sides, and wherein at least two of the exterior edge features in the plurality of exterior edge features are also contiguous so that the portion of the exterior edge having the at least one edge feature comprises a zig zag pattern.

16. The method according to claim 15, wherein the exterior edge of the at least one flake comprises at least three exterior edge portions, and at least two of the exterior edge portions comprise the zig zag pattern.

17. The method according to claim 15, wherein the long reinforcing fibers in the at least one flake are unidirectional and extend through the at least one flake in a first direction and the exterior edge portion comprising the zig zag pattern extends in a second direction that is at an angle with respect to the first direction.

18. The method according to claim 17, wherein the angle between the second direction and the first direction is about 90°.

19. The method according to claim 17, wherein the angle between the second direction and the first direction is about 60° to about 90°.

20. The method according to claim 1, wherein the at least one exterior edge feature is configured to have a shape selected from a triangle shape, a parabola shape, a parallelogram shape, a bell shape, a bullet shape, an arrowhead shape, and a trapezoid shape, and, wherein, when there are more than one exterior edge feature, each exterior edge feature may be the same or different.

21. The method according to claim 20, wherein the at least one exterior edge feature is a parallelogram, having a rectangular shape.

22. The method according to claim 20, wherein there are two or more exterior edge features on the portion of the exterior edge having the edge features and together the exterior edge features form a pattern.

23. The method according to claim 22, wherein the at least one flake has four exterior edge portions, two of which are opposing exterior edge portions, each of which two opposing exterior edge portions has the pattern formed thereon so that the pattern extends along substantially all of the two opposing exterior edge portions and so that a distance measured across the at least one flake longitudinally between the two opposing edge portions remains substantially the same throughout the pattern.

24. The method according to claim 1, wherein the polymeric matrix material is a thermoplastic and is one or more of a polysulfone, a polysulfide, a polyimide, a polyamideimide, a polyamide, a polyarylene polymer, a fluoropolymer, and combinations and copolymers thereof.

25. The method according to claim 24, wherein the polymeric matrix material is a polyarylene polymer that is one or more of polyether ketones, polyetherether ketones, polyetherketone ketones, and combinations and copolymers thereof.

26. The method according to claim 24, wherein the polymeric matrix material is a fluoropolymer that is at least one of copolymers of tetrafluoroethylene and at least one perfluoroalkylvinyl ether; copolymers of tetrafluoroethylene and at least one other perfluorinated alkylene, polychlorotrifluoroethylene, ethyl chlorotrifluoroethylene, ethyltrifluoroethylene, polyvinylidene fluoride, polyvinyl fluoride, and combinations and copolymers thereof.

27. The method according to claim 1, wherein the polymeric matrix material is a thermoset polymer and is one or more of thermoset elastomers, epoxy resins, thermosetting biscitraconicimides, bismaleimides, bismaleimide/triazine/epoxy resins, cyanate esters, cyanate resins, furanic resins, phenolic resins, urea-formaldehyde resins, melamine-formaldehyde resins, phthalocyanine resins, polybenzoxazole resins, acetylene-terminated polyimide resins, silicones, polytriazines, thermosetting polyvinyl esters, thermosetting polyurethanes, polytetrafluoroethylene, melamines, polyalkyds, and xylene resins

28. The method according to claim 1, wherein the long reinforcing fibers in the at least one flake are one or more of inorganic fibers, ceramic fibers, glass fibers, graphite fibers, carbon fibers, thermoplastic fibers, thermosetting fibers, and combinations thereof.

29. The method according to claim 1, wherein the exterior edge of the at least one flake defines on the exterior surface of the at least one flake a surface area having an overall shape that is generally a triangle, a polygon having at least five sides, a circle, a parallelogram or a trapezoid, and the at least one exterior edge feature is formed on at least one edge portion of such surface area shape.

30. The method according to claim 29, wherein the surface area defined by the exterior edge is a parallelogram selected from a square, a rectangle and a rhombus.

31. The method according to claim 29, wherein, there are a plurality of flakes, each having the surface area defined on the exterior surface of the flake by the exterior edge of the flake and having a thickness measured along the exterior edge of each flake in a plane orthogonal to the surface area of the flake, and wherein an average exterior surface area for the plurality of flakes is about 20 square millimeters to about 650 square millimeters and an average thickness of the plurality of flakes is about 0.05 mm to about 0.25 mm.

32. The method according to claim 31, wherein an average exterior surface area of the plurality of flakes is about 150 square millimeters to about 170 square millimeters, and the average thickness of the plurality of flakes is about 0.1 to about 0.20 mm.

33. The method according to claim 1, wherein, when an article is formed using a plurality of the modified polymeric composite flakes having the exterior edge features, and the article formed has an average tensile strength that is at least about 30% greater than a tensile strength of an article formed using a plurality of flakes formed of the same material, and having a same overall shape and size, but that lack the exterior edge features.

34. The method according to claim 33, wherein the average tensile strength of the article formed using the plurality of the modified polymeric composite flakes is at least about 40% to about 60% greater.

35. The method according to claim 1, wherein the at least one exterior edge feature has at least two angled sides, and wherein the at least two angled sides of each exterior edge feature on the at least one modified flake are contiguous and together form a vertex of an angle at a point of contact between the at least two angled sides, and wherein there are a plurality of the exterior edge features on the at least one modified polymeric composite flake and at least two of the angled features in the plurality of exterior edge features are also contiguous so that a portion of the exterior edge of the at least one modified polymeric composite flake comprises a zig zag pattern.

36. The method according to claim 35, wherein there are about two to about twelve of the exterior edge features in the zig zag pattern on the at least one modified polymeric composite flake.

37. The method according to claim 36, wherein there are about four to about eight of the exterior edge features in the zig zag pattern.

38. The method according to claim 36, wherein the at least one modified polymeric composite flake comprises at least three exterior edge portions, at least two of which have the zig zag pattern.

39. The method according to claim 38, wherein there are about four to about eight of the exterior edge features in the zig zag pattern.

40-79. (canceled)
